(19) United States
(12) Patent Application Publication
(10) Pub. No.: US 2026/0021609 A1
(43) Pub. Date: Jan. 22, 2026

(54) BOULES WITH BOULE-HANDLING CARRIER PROCESSING METHODS

(71) Applicant: Wolfspeed, Inc., Durham, NC (US)

(72) Inventors: Devon Diehl, Durham, NC (US); Suresh Sapkota, Durham, NC (US)

(21) Appl. No.: 18/778,375

(22) Filed: Jul. 19, 2024

(51) Int. Cl. B28D 5/00

(52) U.S. Cl. CPC B28D 5/0029

(57) ABSTRACT

Methods of processing crystalline material include providing a boule with the crystalline material, the boule having a bottom end and an opposed top end; providing a boule-handling carrier that has a first surface extending in a first plane and an opposing second surface extending in a second plane. The second surface can be provided as parallel to the first surface or not parallel to the first surface. The methods include bonding the second surface of the carrier to the bottom end of the boule and then performing at least one processing step on the top end of the boule.

### TECHNICAL FIELD

The present disclosure relates to methods for processing crystalline materials, and more specifically to carrier-assisted methods for processing a boule.

### BACKGROUND

Various microelectronic, optoelectronic, and microfabrication applications require thin layers of crystalline materials as a starting structure for various systems. Different methods for separating thin layers or slices (e.g., wafers) from boules (which is also interchangeably referred to as “ingots”) of crystalline materials are known to those of skill in the art. For example, wire sawing technology, laser wafering and ion implantation techniques in conjunction with thermal/cooling systems in combination with polymer layers, temporary carriers and ultrasound energy systems have been proposed or used.

One example technique involving removal of a layer of silicon carbide from a larger crystal is described in Kim et al., “4H—SiC wafer slicing by using femtosecond laser double pulses,” Optical Materials Express 2450, vol. 7, no. 7 (2017). This technique involves formation of laser-written tracks by impingement of laser pulses on silicon carbide to induce subsurface damage, followed by adhesion of the crystal to a locking jig and application of tensile force to effectuate fracture along a subsurface damage zone. Use of the laser to weaken specific areas in the material followed by fracture between those areas reduces the laser scanning time. However, it is doubtful that this fracture technique may be applied to reliably remove thin wafers from an ingot without breakage and/or may be scaled up to commercial volumes. Another technique known in the art for effectuating fracture along a layer of subsurface damage of a crystalline material involves application of ultrasonic energy to the crystalline material, but the reliability or yields of such method for obtaining thin wafers (e.g., 350 microns or less) has been questioned, since ultrasonic fracturing may require a higher degree of damage and may result in higher wafer breakage rates when applied to thin wafers.

A further technique for removing thin layers of crystalline materials from bulk crystals is disclosed in U.S. Patent Application Publication No. 2018/0126484A1. Laser radiation is impinged on a solid-state material to create a detachment zone or multiple partial detachment zones, followed by formation of a polymer receiving layer (e.g., PDMS) and cooling (optionally combined with high-speed rotation) to induce mechanical stresses that cause a thin layer of the solid-state material to separate from a remainder of the material along the detachment zone(s). The resulting wafers, however, may exhibit undesirably high levels of bowing.

Yet another technique for removing thin layers of crystalline materials from bulk crystals is disclosed in U.S. Patent Application Publication No. 2018/0243944A1. Laser radiation is impinged on a donor substrate in order to specify a crack course, a carrier substrate (i.e., having a thickness of less than 800 microns) is bonded to the donor substrate via a bonding layer, a stress-producing layer (e.g., PDMS layer) is provided on the carrier substrate, and the stress-producing layer is thermally loaded (i.e., cooled with a coolant, particularly liquid nitrogen) to transmit stress through the carrier substrate and bonding layer to produce stresses in the donor substrate to trigger a crack that is propagated on the crack course to remove the solid layer (and carrier substrate bonded thereto) from the donor substrate.

A problem can arise when separating wafers from a boule about subsurface damage layers as the boule can be chipped or otherwise damaged due to handling and exposure to multiple workstations to carry out multiple wafer separation actions involving ion implantation or laser induced damage. That is, the bottom surface of the boule can be damaged. Another problem can arise as the boule gets thin as the wafer separation of respective wafers can be difficult so that the remnant boule may be hard to be able to successfully remove intact wafers from during the wafer separation process.

It is possible to produce vicinal (also known as offcut or “off-axis”) boules having end faces that are not parallel to the crystallographic c-plane in contrast to “on axis” boules. Vicinal boules (e.g., of SiC) having about a 4 degree offcut are frequently employed as growth substrates for high-quality epitaxial growth of other materials (e.g., AlN and other Group III nitrides).

In the case of silicon carbide (SiC), wafers from boules of SiC can be used to fabricate desirable power electronic, radio frequency, and optoelectronic devices. SiC occurs in many different crystal structures called polytypes, with certain polytypes (e.g., 4H—SiC and 6H—SIC) having a hexagonal crystal structure.

A problem with processing off-axis boules is the cost and time associated with preparing a boule for subsequent wafer separating processing as conventional systems require high cost EDM machines which can also require relatively lengthy manufacturing lead times.

There remains a need for processes that can reduce cost, improve yield and/or facilitate wafer separation of crystalline materials.

### SUMMARY

The present disclosure relates in various aspects to crystalline material processing methods which use a boule-handling carrier bonded to a bottom end face of a boule of crystalline material while the top end face is processed to serially separate wafers from the boule such that the carrier remains bonded to the bottom end face down to a small remaining amount (“remnant”) of boule.

The boule-handling carrier can have an inclined surface.

The boule-handling carrier can provide anti-chip protection for the boule.

The boule-handling carrier can provide an improved energy directivity for the separation process as the boule reduces in volume and size during the separation steps for the different wafers whereby the separation occurs in response to separation processing without requiring manual intervention.

The boule-handling carrier can be removed from the boule after wafers are removed down to a small remaining volume of boule and reused with another boule.

The boule-handling carrier can have a lateral extent that is greater than the boule and/or an outer perimeter with a shaped edge that may have the form of one or more of a fillet, bevel or chamfer to facilitate longevity (avoid chipping upon surface contact at different workstations) and/or separation from the boule.

The boule-handling carrier can be bonded to the boule using an adhesive that provides a holding force that has minimal, if any, degradation when exposed to high energy ultrasound during at least 10 different separating steps, one for each of at least 10 wafers, and can allow separation of wafers from the boule down to a remaining boule height of about 1 mm or less, such as about 300 μm height thereof when using ultrasound separation systems.

The boule-handling carrier can be provided by a UV transparent glass, such as a borosilicate glass or quartz.

The boule can have subsurface damage at a non-zero depth relative to the surface, followed by separating (fracturing, sawing, cutting or otherwise separating) a wafer from the crystalline material along the subsurface damage region.

In certain implementations, fracturing of the crystalline material may be promoted by (i) application of a mechanical force (e.g., optionally localized at one or more points) or motion applied to the boule (e.g., pulling and/or twisting from opposing top and bottom directions); (ii) cooling the boule; and/or (iii) application of ultrasonic energy to the crystalline material.

In certain embodiments, at least one of a first thin wafer or a second thin wafer has a thickness of less than 300 microns such as about 250 microns or less. In certain embodiments, the crystalline material includes or is SiC.

Embodiments of the present disclosure are directed to methods of processing crystalline material. The methods include: providing a boule having the crystalline material, the boule having a top end and an opposed bottom end; and providing a boule-handling carrier that has a first surface extending in a first plane and an opposing second surface extending in a second plane. The second surface is not parallel to the first surface. The methods also include bonding the second surface of the boule-handling carrier to the bottom end of the boule and then performing at least one processing step on the top end of the boule.

The performing can include grinding the top end of the boule so that the top end of the boule has a planar surface that is parallel to the first surface of the boule-handling carrier.

The second surface of the boule-handling carrier can have an angle of inclination from horizontal that corresponds to an angle of a crystal plane of the boule.

The performing can include separating wafers from the top end of the boule.

The second surface of the boule-handling carrier can extend at an angle of inclination with respect to the first plane that increases from one side to an opposing side thereof.

The angle of inclination with respect to the first plane can be greater than zero degrees and less than about 15 degrees.

The top end of the boule can have a curvilinear surface prior to the (initial) grinding.

The performing can include separating a wafer from the top end of the boule then grinding and/or polishing a newly exposed surface at the top end of the boule.

The performing can include processing the boule sequentially through a plurality of workstations to prepare an exposed surface at the top end of the boule then separate respective wafers from the boule while the boule-handling carrier remains attached to the bottom end of the boule.

The boule-handling carrier can have an outer perimeter with a shaped edge.

The shaped edge can be a fillet, a bevel portion or a chamfer portion.

The boule can extend along a longitudinal axis. The boule-handling carrier can have a lateral extent that is greater than a lateral extent (which is perpendicular to the longitudinal axis) of the boule.

The angle of inclination can be in a range of about 1 degree and about 10 degrees with respect to the first plane.

The angle of inclination can be about 4 degrees from horizontal.

The boule-handling carrier can be ultraviolet light transmissive. The bonding can be performed using an ultraviolet light curable adhesive.

The boule-handling carrier can be floated borosilicate glass. The bonding can be performed using a two-part epoxy with resin and hardener.

Wafers can be separated from the top end of the boule down to a last 300 μm thickness or less of the boule adjacent the bottom end while the boule-holding carrier is bonded to the boule and the separations can be carried out without the use of manual separation.

The boule can be a silicon carbide boule.

The grinding can be a preparatory grinding to planarize at least a portion of the top end of the boule. The performing can include processing the boule sequentially through a plurality of workstations to separate respective wafers from the boule while the boule-handling carrier remains attached to the bottom end of the boule during the processing whereby wafers are separated down to a bottom remnant portion of the boule adjacent the bottom end of the boule.

The performing can include sequentially separating a plurality of wafers in response to different wafer separation events, and the boule-handling carrier and the boule can remain bonded throughout exposure to ultrasound separation energy applied at a plurality of different times by an ultrasonic separation workstation for at least 10 different wafer separation events to provide the plurality of separated wafers.

At least one of the plurality of workstations can be a grinding workstation which can have a vacuum chuck that holds the boule-handling carrier bonded to the boule, and the boule-handling carrier and boule can remain bonded throughout exposure to load forces applied by the grinding workstation during at least 10 different grinding operations at different times following different separation events to separate respective wafers during the processing.

Yet other embodiments are directed to methods of processing crystalline material that include: providing a boule of the crystalline material comprising a top end and an opposing bottom end; bonding a boule-handling carrier to the bottom end of the boule; separating a wafer from the top end of the boule; performing at least one of a grinding step and a polishing step after separating the wafer from the boule to grind and/or polish any residual damage on a newly exposed surface at the top end of the boule while the boule-handling carrier remains bonded to the boule; and maintaining the boule-handling carrier bonded to the bottom end of the boule during subsequent steps of separating whereby wafers are separated down to at least a last 1 mm thickness, optionally down to at least a 300 μm thickness, of the boule adjacent the bottom end.

The separating comprises impinging ultrasonic energy into the boule.

The boule-handling carrier can have an inclined surface attached to the bottom end of the boule.

The inclined surface can have an angle of inclination in a range of above 0 degrees and below about 15 degrees with respect to the first plane.

The angle of inclination can be about 4 degrees with respect to the first plane.

Still other embodiments are directed to methods of processing crystalline material that include: providing a boule of the crystalline material comprising a bottom end and an opposing top end; bonding a boule-handling carrier to the bottom end of the boule; generating subsurface damage adjacent the top end of the boule; directing ultrasound energy to the boule to separate a wafer about the subsurface damage from the top end of the boule; then performing at least one of a grinding and polishing step to a newly exposed substrate surface of the boule after the wafer is separated while the boule-handling carrier remains bonded to the bottom end of the boule; and repeating the directing and performing steps a plurality of times while the boule-handling carrier remains bonded to the bottom end of the boule.

The top end of the boule can be bare during the directing.

Wafers can be separable from the boule down to at least a last 300 μm thickness of the boule while the boule-handling carrier is bonded to the boule.

The boule-handling carrier can be formed of an ultraviolet light transmissive material, and the bonding can be carried out using an ultraviolet (UV) light curable adhesive.

The boule-handling carrier can be provided as floated borosilicate flat glass.

The boule can be a silicon carbide boule.

The method can further include partially planarizing the top end before the generating step.

The separated wafers can each have at least one epitaxial layer grown thereon.

Other embodiments are directed to methods of processing crystalline material that include: providing a boule of the crystalline material comprising a bottom end and an opposing top end; and bonding a boule-handling carrier to the bottom end of the boule. The boule-handling carrier includes an outer perimeter with a shaped edge.

The shaped edge comprises one or more of a fillet, a chamfer or a bevel.

The shaped edge can project outward from a lower segment adjacent a surface of the boule-handling carrier away from the boule.

The method can further include separating a wafer from the top end of the boule; performing at least one of a grinding and polishing step on a newly exposed surface at the top end of the boule after separating the wafer from the boule while the boule-handling carrier remains bonded to the boule; and repeating the separating and performing steps while the boule-handling carrier remains bonded to the bottom end of the boule.

The separating can include impinging ultrasonic energy onto the boule.

The method can include, before the separating, creating subsurface damage adjacent the top end of the boule while the bottom end of the boule is bonded to the boule-handling carrier and the separating can fracture the boule about the subsurface damage.

The boule-handling carrier can have at least one alignment feature and/or at least one retention feature. The alignment feature can be a fiducial. The retention feature can include inwardly extending channels or laterally extending channels.

The boule-handing carrier can have a tracking device therein or thereon.

In another aspect, any of the foregoing aspects, and/or various separate aspects and features as described herein, may be combined for additional advantage. Any of the various features and elements as disclosed herein may be combined with one or more other disclosed features and elements unless indicated to the contrary herein.

Other aspects, features and embodiments of the present disclosure will be more fully apparent from the ensuing disclosure and appended claims.

In addition, it is noted that aspects of the present inventive concept that are described with respect to one embodiment, may be incorporated in a different embodiment although not specifically described relative thereto. That is, all embodiments and/or features of any embodiment can be combined in any way and/or combination for any number of desired activities and/or any degree of activity performance complexity or variability.

Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in more detail in the specification set forth below.

### BRIEF DESCRIPTION OF DRAWINGS

The accompanying drawings incorporated in and forming a part of this specification illustrate several aspects of the disclosure, and together with the description serve to explain the principles of the disclosure.

FIG. 1 is a first perspective view crystal plane diagram showing the coordinate system for a hexagonal crystal such as 4H-SiC.

FIG. 2 is a second perspective view crystal plane diagram for a hexagonal crystal, illustrating a vicinal plane that is non-parallel to the c-plane.

FIG. 3A is a perspective view wafer orientation diagram showing the orientation of a vicinal wafer relative to the c-plane.

FIG. 3B is a simplified cross-sectional view of the vicinal wafer of FIG. 3A superimposed over a portion of a boule.

FIG. 3C is a perspective view of a wafer orientation diagram showing the orientation of an on-axis wafer relative to the c-plane.

FIG. 3D is a simplified cross-sectional view of the wafer of FIG. 3C superimposed over a portion of a boule.

FIG. 4 is a top plan view of an exemplary SiC wafer.

FIG. 5A is a side elevation schematic view of an on-axis boule of crystalline material.

FIG. 5B is a side elevation schematic view of the boule of FIG. 5A being rotated by 4 degrees, with a superimposed pattern for cutting end portions of the boule.

FIG. 5C is a side elevation schematic view of a boule following removal of end portions to provide end faces that are non-perpendicular to the c-direction.

FIG. 5D is a side elevation schematic view of an off-axis grown boule of crystalline material.

FIG. 5E is a side elevation schematic view of an off-axis grown boule having end faces that are non-perpendicular to the c-direction.

FIG. 6 is a simplified schematic illustration of a boule processing method according to embodiments of the present invention.

FIG. 7A is a simplified schematic illustration of another boule processing method according to embodiments of the present invention.

FIG. 7B is a simplified schematic illustration of yet another boule processing method according to embodiments of the present invention.

FIGS. 8A-8J are schematic upper surface views of example boule-handling carriers comprising example adhesive patterns for providing a sufficient bond for the boule and boule-handling carrier according to embodiments of the present invention.

FIGS. 9A-9C are perspective schematic views of a moveable laser tool configured to focus laser emissions within an interior of a crystalline material coupled to respective example boule-handling carriers to form subsurface damage.

FIG. 10 is a side cross-sectional schematic view of an assembly including a crystalline material substrate having subsurface damage and joined to (only) a boule-handling carrier with adhesive material according to embodiments of the present invention.

FIG. 11A is a cross-sectional schematic view of an assembly including a boule-handling carrier, and an optional wafer-handling carrier, joined to a boule of crystalline material having a subsurface damage region according to embodiments of the present invention.

FIG. 11B is a cross-sectional schematic view of the assembly of FIG. 11A, with a surface of the boule-handling carrier being positioned on a vacuum chuck and optionally a wafer side of the boule coupled to a different vacuum chuck.

FIG. 11C is a cross-sectional schematic view of a first bonded assembly comprising a majority of the boule of crystalline material bonded to the boule-handling carrier separated from a thin portion (wafer) of the crystalline material removed from the boule/substrate, following fracture of the crystalline material along the subsurface damage region.

FIG. 12A is a schematic view of an assembly of the boule-handling carrier bonded to a remnant of boule after a series of wafer separation actions and in communication with a heat source for separating the boule-handling carrier from the remnant according to embodiments of the present invention.

FIG. 12B is a schematic view of the assembly shown in FIG. 12A with the remnant separated from the boule-handling carrier based at least in part on exposure to heat from the heat source according to embodiments of the present invention.

FIG. 13 is a perspective view illustration of a cooling apparatus including a vacuum chuck arranged proximate to a bottom wall of a vessel arranged to receive a liquid coolant (e.g., methanol received from an evaporative cooling system, liquid nitrogen, or the like).

FIGS. 14A-14E are top views of bonded assemblies including boule-handling carriers of different shapes each joined to a substrate of crystalline material.

FIGS. 14F, 14G and 14H are side cross-sectional schematic views of bonded assemblies of boule-handling carriers and a crystalline material according to embodiments of the present invention.

FIGS. 141-14M are side perspective views of example boule-handling carriers according to embodiments of the present invention.

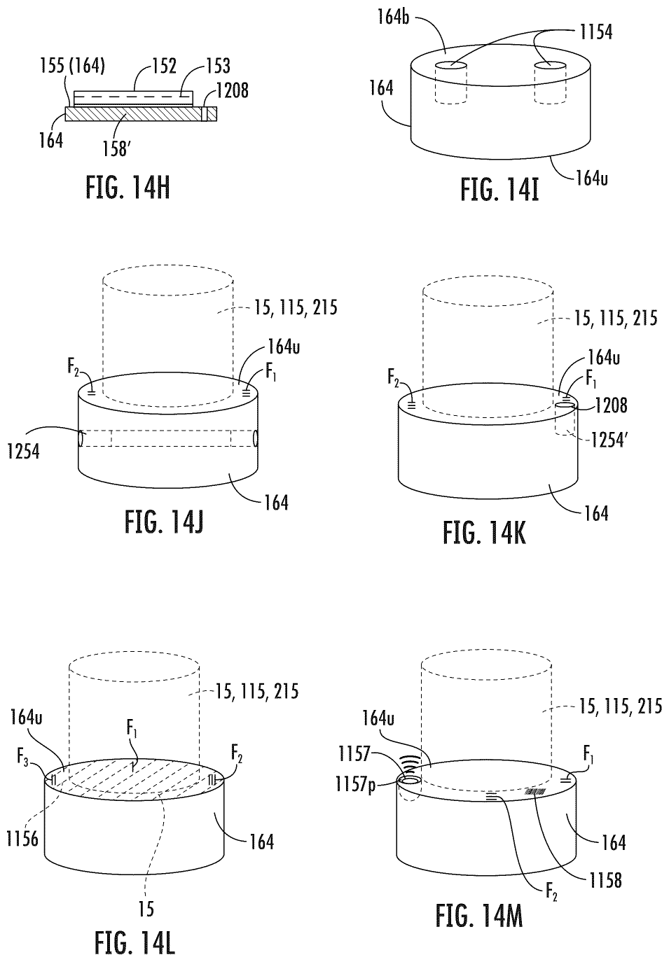

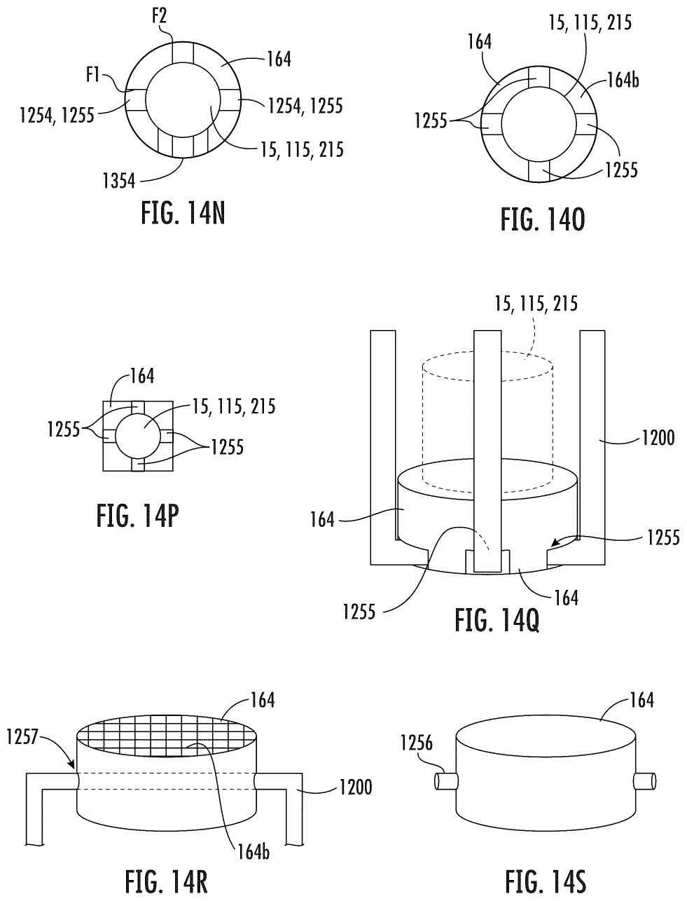

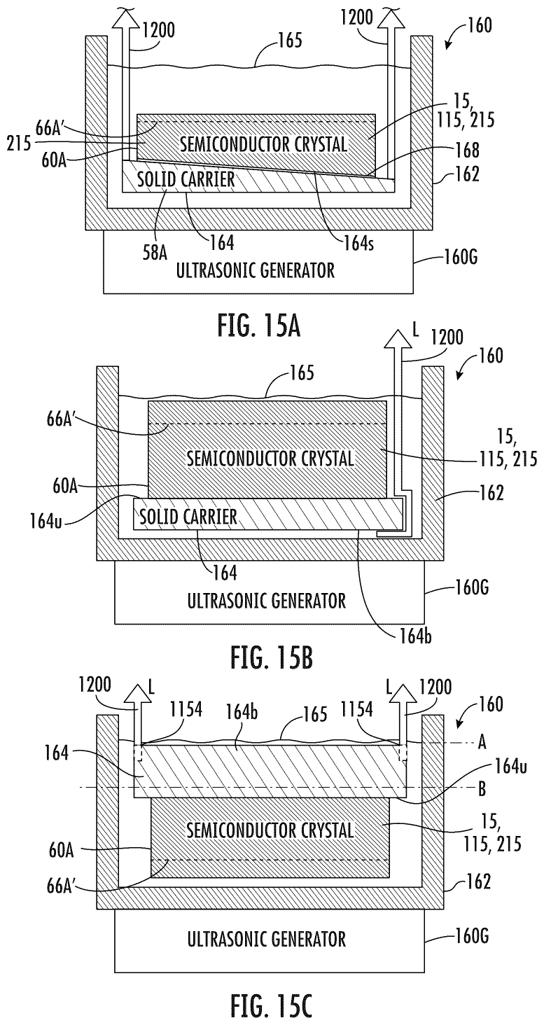

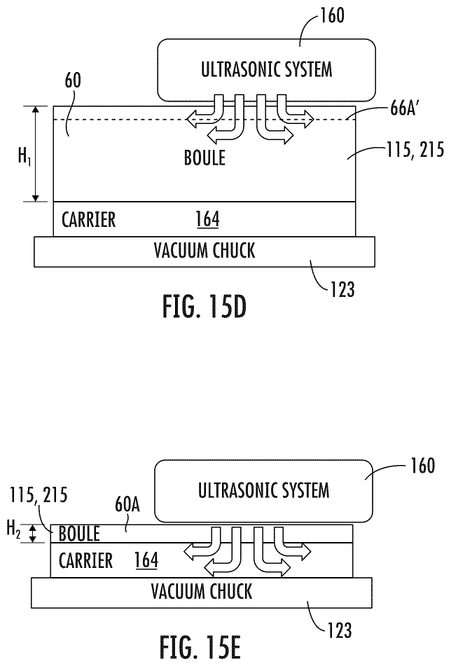

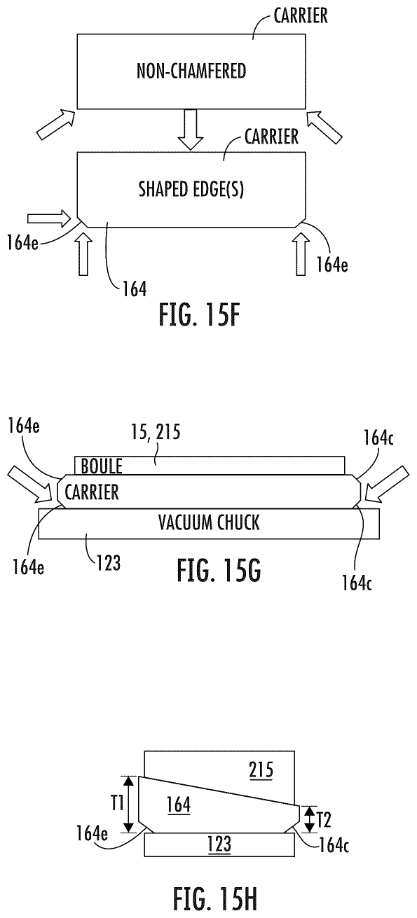

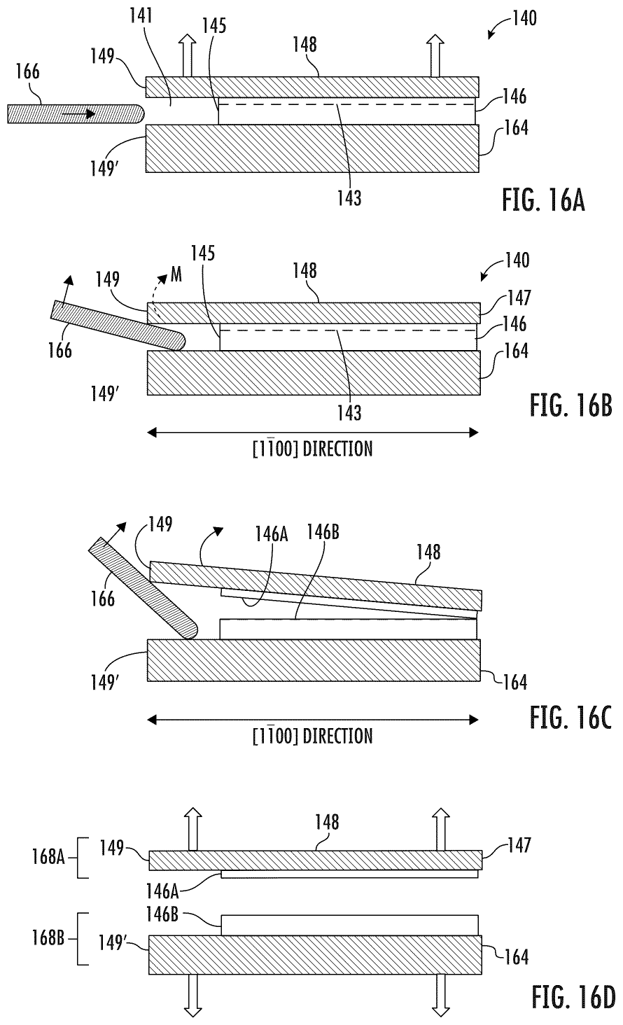

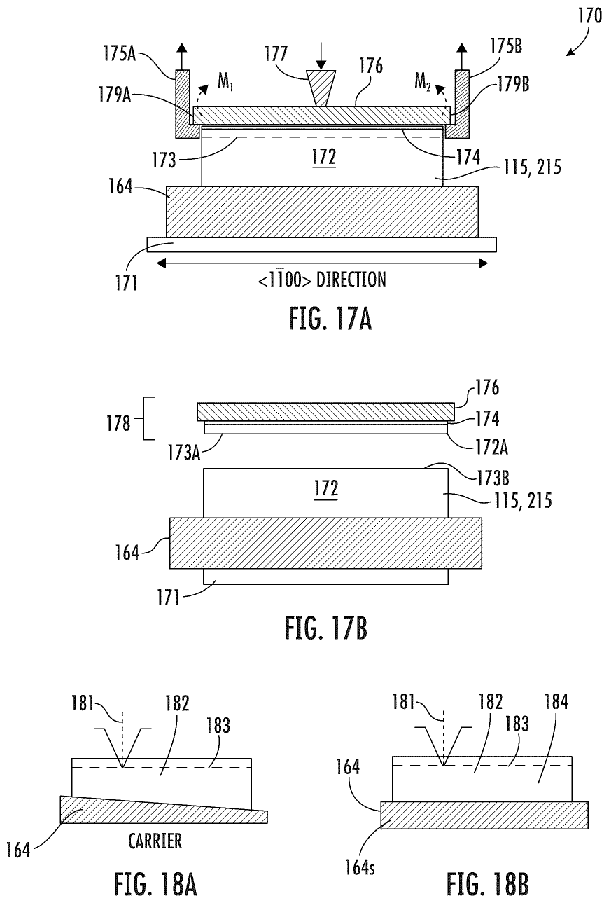

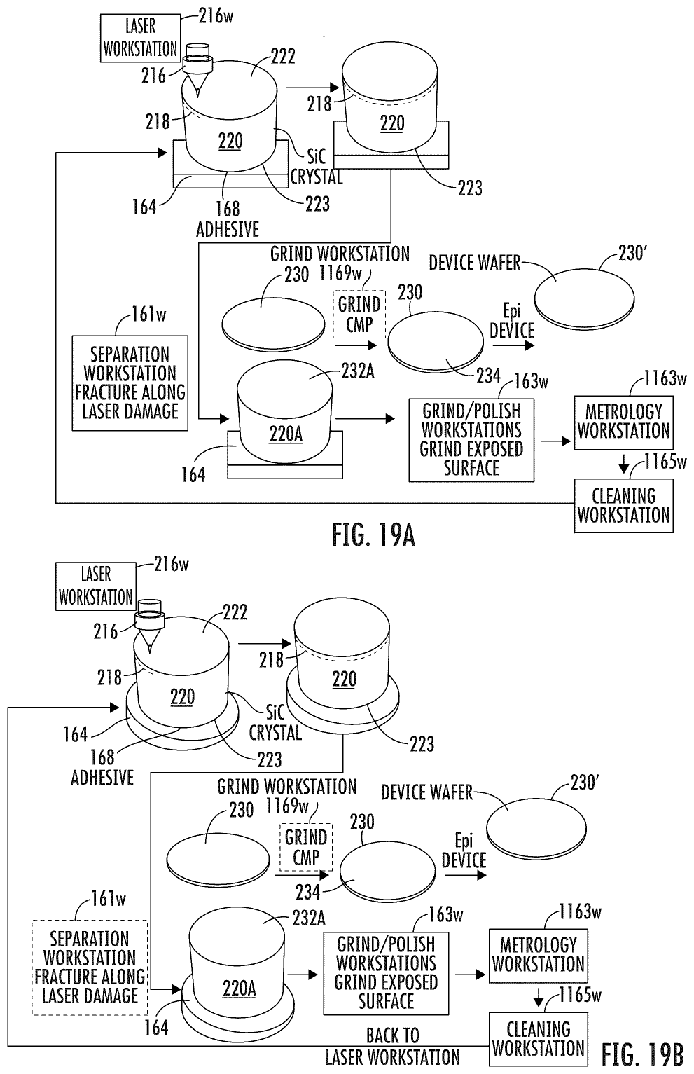

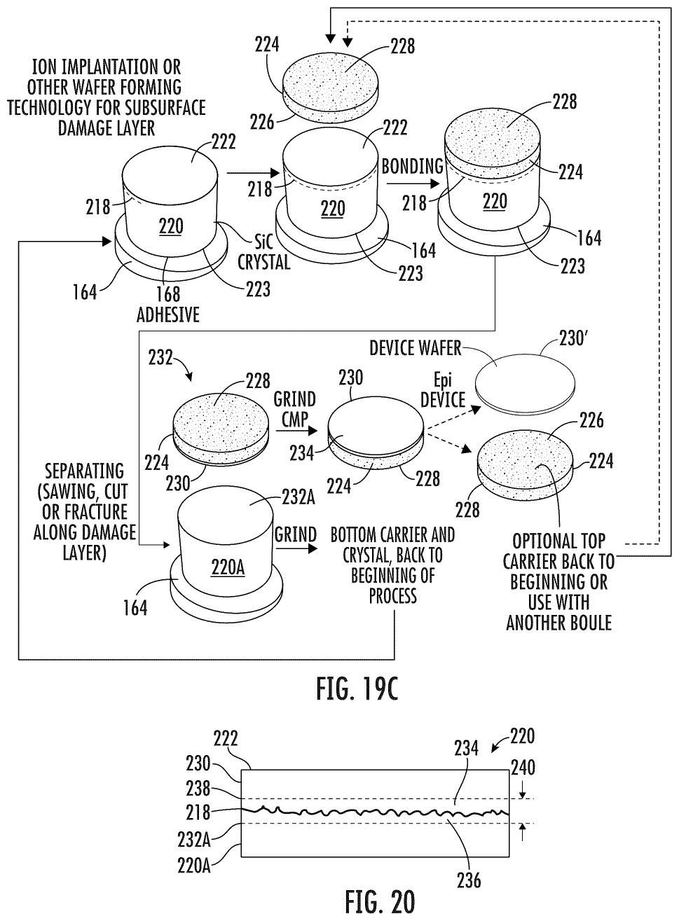

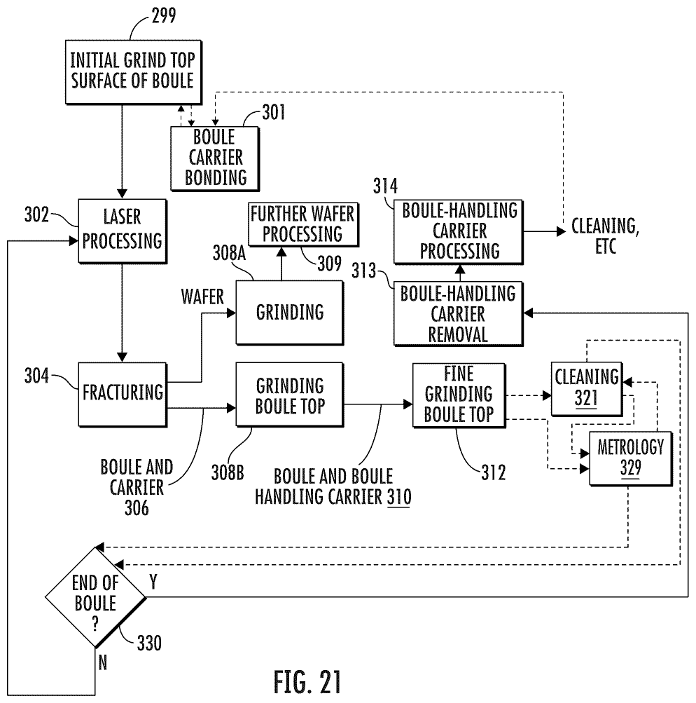

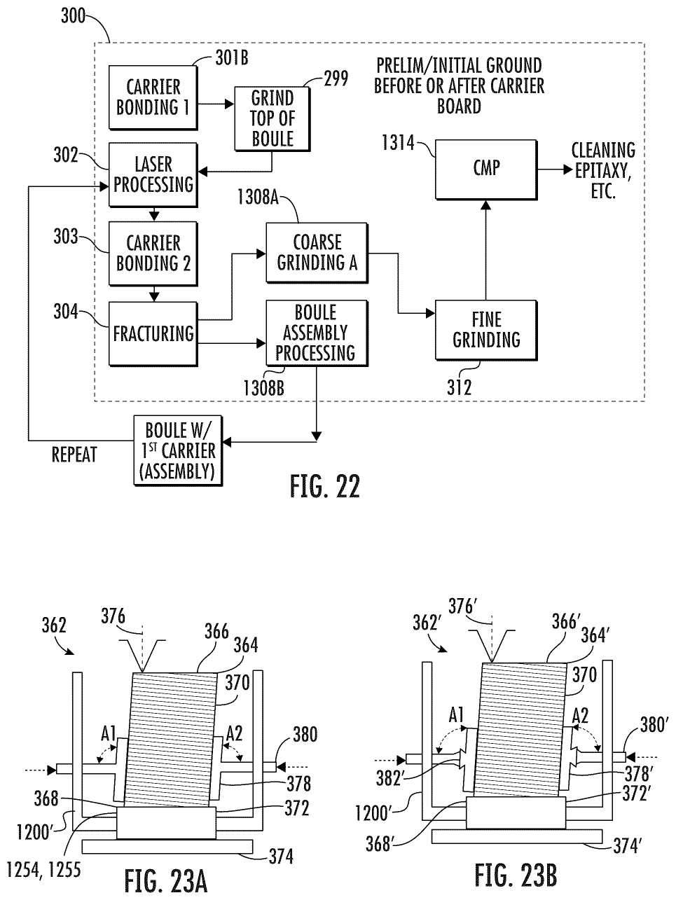

FIGS. 14N-14P are end views of example boule-handling carriers according to embodiments of the present invention.

FIGS. 14Q and 14R are side perspective views of example boule-handling carriers with mechanical members coupled to the boule-handling carriers for facilitating automated processing according to embodiments of the present invention.

FIG. 14S is a schematic illustration of an example boule-handling carrier with outwardly projecting members providing alignment and/or handling interfaces for facilitating automated processing according to embodiments of the present invention.

FIG. 15A is a cross-sectional schematic view of a boule of crystalline material having subsurface damage and bonded to a boule-handling carrier, having an inclined surface, with the crystalline material arranged in a liquid bath of an ultrasonic system for separating wafers from an exposed end of the boule with the subsurface damage.

FIG. 15B is a cross-sectional schematic view of a boule of crystalline material having subsurface damage and bonded to a boule-handling carrier with the crystalline material arranged in a liquid bath of an ultrasonic system for separating wafers from the exposed end of the boule of crystalline material with the subsurface damage, similar to the embodiment shown in FIG. 15A, but illustrating that the boule-handling carrier has a horizontal surface facing the boule.

FIG. 15C is a cross-sectional schematic view of a boule of crystalline material having subsurface damage and bonded to the boule-handling carrier with the crystalline material arranged in a liquid bath of an ultrasonic system for separating wafers from the exposed end of the boule of crystalline material with the subsurface damage oriented to face inward.

FIG. 15D is a schematic view of a boule of crystalline material having subsurface damage and bonded to the boule-handling carrier, with the crystalline material and carrier coupled to an ultrasonic system and with the boule at a first height for removing wafers therefrom.

FIG. 15E is a schematic view of the boule of crystalline material having subsurface damage and bonded to the boule-handling carrier shown in FIG. 15D, with the crystalline material and boule-handling carrier coupled to the ultrasonic system but with the boule of the crystalline material at a reduced height relative to the boule shown in FIG. 15D with the boule-handling carrier providing improved ultrasonic energy distribution within the reduced height boule relative to conventional processing.

FIG. 15F is a schematic section view of a boule-handling carrier with a shaped outer perimeter edge according to embodiments of the present invention.

FIG. 15G is a schematic section view of a boule and the boule-handling carrier, similar to that shown in FIG. 15E, but illustrating optional shape outer perimeter edges of the carrier, shown with upper and lower shaped outer edges, recognizing one or both of the upper and/or lower shaped edges may be used.

FIG. 15H is a schematic section view of a boule-handling carrier with an inclined surface coupled to a boule with the carrier comprising a shaped outer perimeter edge according to embodiments of the present invention.

FIGS. 16A-16D are cross-sectional schematic views illustrating steps for fracturing a crystalline material having subsurface damage including application of a mechanical force proximate to one edge of a carrier to impart a bending moment in at least a portion of the carrier.

FIG. 17A is a cross-sectional schematic view of an apparatus for fracturing a boule of crystalline material having subsurface damage with boule-handling and wafer-handling carriers bonded thereto by applying mechanical force along opposing edges of the wafer-handling carrier to impart bending moments in portions of the wafer-handling carrier.

FIG. 17B is a cross-sectional schematic view of a bonded assembly including a wafer-handling carrier and wafer and a bulk boule portion with the boule-handling carrier and bulk boule portion separated using the apparatus of FIG. 17A.

FIGS. 18A-18B are cross-sectional schematic views of formation of subsurface laser damage in a substrate of crystalline material by focusing laser emissions into a bare end of the crystalline material while the boule is coupled to a boule-handling carrier at an opposing end thereof.

FIG. 19A is a pictorial flowchart schematically illustrating steps for producing subsurface laser damage to a crystalline (e.g., SiC) material boule previously coupled to a boule-handling carrier, followed by parting of a wafer of the crystalline material, followed by further processing of the wafer and formation of epitaxial layers on the wafer, and grind/polish, metrology and clean workstations for the boule with the boule-handling carrier, then return of the boule with the boule-handling carrier to a beginning of the process for separation of an additional wafer.

FIG. 19B is a pictorial flowchart similar to that shown in FIG. 19A but showing that the boule-handling carrier may have an inclined surface.

FIG. 19C is a pictorial flowchart schematically illustrating steps for producing subsurface damage to a crystalline (e.g., SiC) material ingot (by any suitable wafer forming technology) previously coupled to the boule-handling carrier, followed by parting of a bonded assembly comprising a wafer of the crystalline material and wafer carrier, followed by further processing of the wafer and formation of epitaxial layers on the wafer, with return of the boule with the coupled boule-handling carrier to a beginning of the process.

FIG. 20 is an enlarged cross-sectional schematic view of a portion of the boule of FIGS. 19A, 19B and/or 19C showing subsurface laser damage with superimposed dashed lines identifying an anticipated kerf loss material region attributable to subsurface damage and subsequent surface processing (e.g., grinding and polishing or “fine grinding”).

FIG. 21 is a schematic illustration of a material processing system according to example embodiments, including a boule-handling carrier bonding station, then a processing station, a material fracturing station, multiple grinding stations, and a boule-handling carrier removal station at end of boule processing.

FIG. 22 is a schematic illustration of a material processing system according to other example embodiments with two different carrier bonding stations.

FIG. 23A is a schematic side cross-sectional view of a first apparatus for holding an ingot/boule having end faces that are non-perpendicular to a sidewall thereof, according to one embodiment.

FIG. 23B is a schematic side cross-sectional view of a second apparatus for holding an ingot/boule having end faces that are non-perpendicular to a sidewall thereof, according to one embodiment.

### DETAILED DESCRIPTION

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations in use or operation in addition to the orientation depicted in the figures. For example, if a device or system in the figures is inverted, elements described as “under” or “beneath” other elements or features would then be oriented “over” the other elements or features. Thus, the exemplary term “under” can encompass both an orientation of over and under. The view may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise. A sequence of operations (or steps) is not limited to the order presented in the claims or figures unless specifically indicated otherwise.

As used herein, the term “forward” and derivatives thereof refer to the general direction a boule travels as it moves through the material processing system; this term is meant to be synonymous with the term “downstream” which is often used in manufacturing environments to indicate that certain material being acted upon is farther along in the manufacturing process than other material. Conversely, the terms “rearward” and “upstream” and derivatives thereof refer to the directions opposite, respectively, the forward and downstream directions.

Like numbers refer to like elements throughout. In the figures, layers, regions and/or components may be exaggerated for clarity. The word “Figure” is used interchangeably with the abbreviated forms “FIG.” and “Fig.” in the text and/or drawings. Broken lines illustrate “hidden” or optional features or operations unless specified otherwise.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the terms “ingot” and “boule” are used interchangeably to refer to a crystalline material that is divisible into smaller portions such as slices or wafers.

The term “about” with reference to a number, means that the value can vary by +/−20 percent. The term “substantially” with reference to a size or an angular orientation (e.g., horizontal, vertical, parallel, orthogonal, inclination angle and the like) means that the noted feature can vary by +/−10%, and for angular orientation can vary by +/−10 degrees.

Aspects of the present disclosure are discussed with reference to a semiconductor workpiece that is a semiconductor wafer that includes silicon carbide (“silicon carbide semiconductor wafer”) for purposes of illustration and discussion. Those of ordinary skill in the art, using the disclosures provided herein, will understand that aspects of the present disclosure can be used with other semiconductor workpieces, such as other wide bandgap semiconductor workpieces. Other semiconductor workpieces may include carrier substrates, ingots, boules, polycrystalline substrates, monocrystalline substrates, bulk materials having a thickness of greater than 1 millimeter, such as greater than about 5 millimeters, such as greater than about 10 millimeters, such as greater than about 20 millimeters, such as greater than about 50 millimeters, such as greater than about 100 millimeters, such as greater than about 200 millimeters, etc.

In some examples, the semiconductor workpiece includes silicon carbide crystalline material. The silicon carbide crystalline material may have a 4H crystal structure, 6H crystal structure, or other crystal structure. The semiconductor workpiece can be an on-axis workpiece (e.g., end face parallel to the (0001) plane) or an off-axis workpiece (e.g., end face non-parallel to the (0001) plane).

Aspects of the present disclosure may make reference to a surface of the semiconductor workpiece. In some examples, the surface of the workpiece may be, for instance, a silicon face of the workpiece. In some examples, the surface of the workpiece may be, for instance, a carbon face of the workpiece.

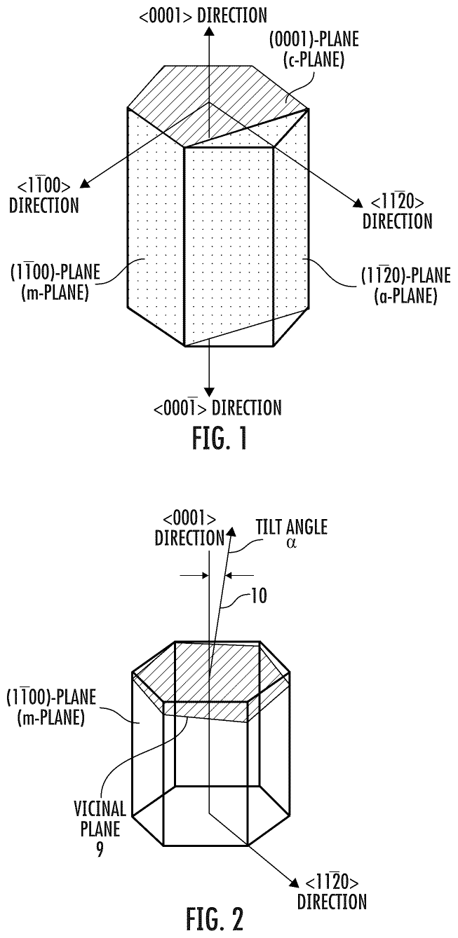

FIG. 1 is a first perspective view crystal plane diagram showing the coordinate system for a hexagonal crystal such as 4H-silicon carbide (“SiC”), in which the c-plane (0001) is perpendicular to both the m-plane (11̅00) and the a-plane (112̅0). The c-plane is perpendicular to the <0001> direction. The m-plane (11̅00) is perpendicular to the <11̅00> direction. The a-plane (112̅0) is perpendicular to the <112̅0> direction. The <0001̅> direction is opposite the <0001> direction.

FIG. 2 is a second perspective view crystal plane diagram for a hexagonal crystal, illustrating a vicinal plane 9 that is non-parallel to the c-plane, wherein a vector 10 (which is normal to the vicinal plane 9) is tilted away from the <0001> direction by a tilt angle α, with the tilt angle α being inclined (slightly) toward the <112̅0> direction.

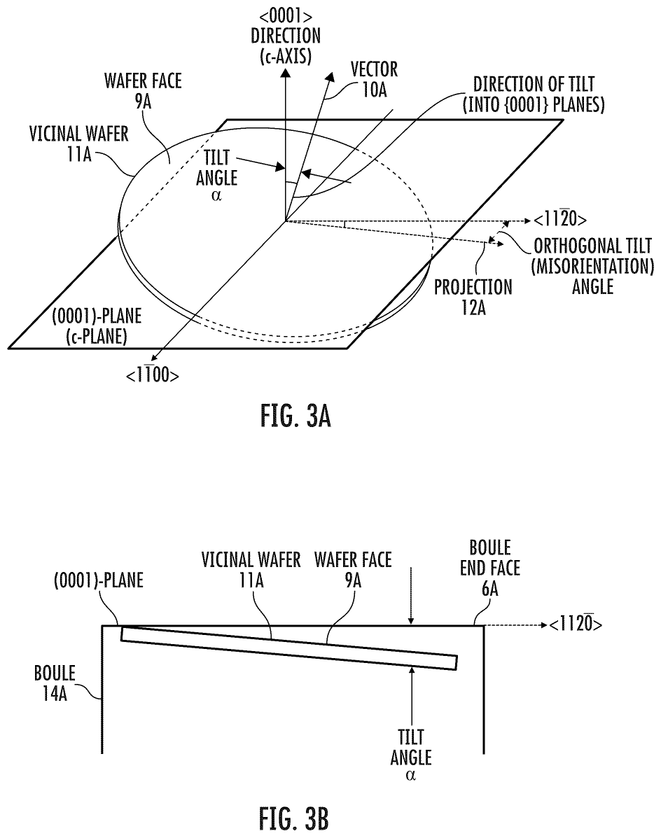

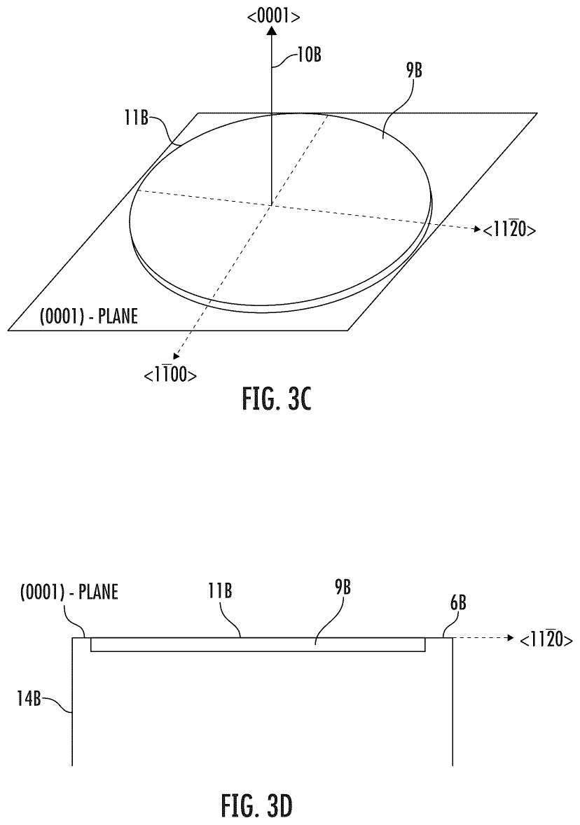

FIG. 3A is a perspective view of a wafer orientation diagram showing the orientation of a vicinal wafer 11A relative to the c-plane (0001), in which a vector 10A (which is normal to the wafer face 9A) is tilted away from the <0001> direction by a tilt angle α. An orthogonal tilt (or misorientation angle) β may span between the <1120> direction and the projection of vector 10A onto the c-plane.

FIG. 3B is a simplified cross-sectional view of the vicinal wafer 11A superimposed over a portion of a boule 14A (e.g., an on-axis boule having an end face 6A parallel to the (0001) plane) from which the vicinal wafer 11A was defined. FIG. 3B shows that the wafer face 9A of the vicinal wafer 11A is misaligned relative to the (0001) plane by a tilt angle α.

FIG. 3C is a perspective view of a wafer orientation diagram showing the orientation of an on-axis wafer 11B relative to the c-plane (0001), in which a vector 10B (which is normal to the wafer face 9B) is parallel to the <0001> direction. FIG. 3D is a simplified cross-sectional view of the wafer 11B superimposed over a portion of a boule 14B (e.g., an on-axis boule having an end face 6B parallel to the (0001) plane). FIG. 3D shows that the wafer face 9B of the on-axis-wafer 11B is aligned with the (0001) plane.

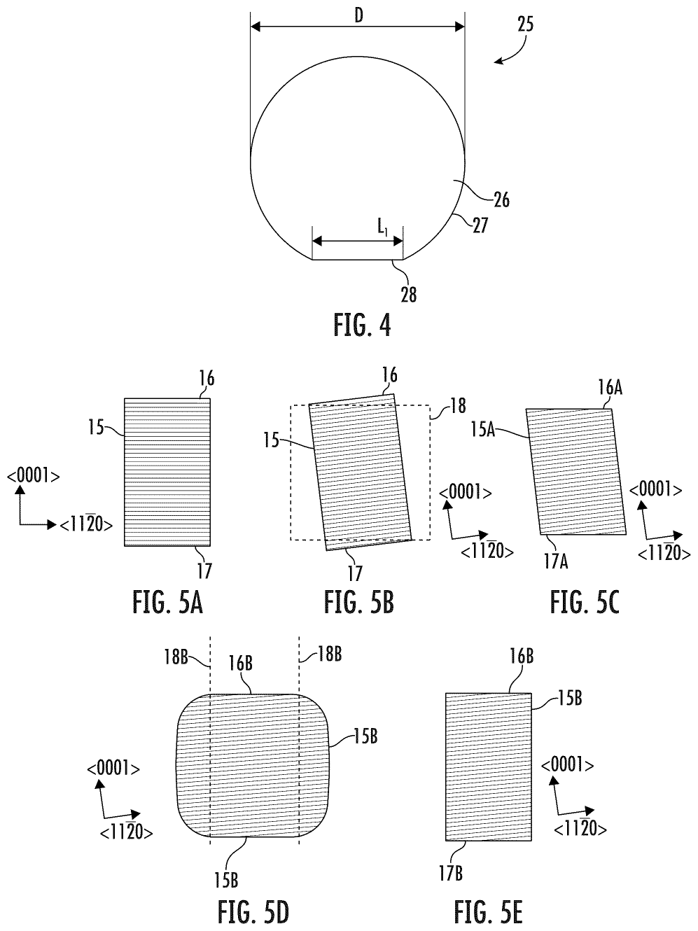

FIG. 4 is a top plan view of an example silicon carbide semiconductor wafer 25 including an upper face 26. The silicon carbide semiconductor wafer 25 may include a surface that is misaligned with (e.g., off-axis at an oblique angle relative to) the c-plane. The silicon carbide semiconductor wafer 25 may be laterally bounded by a generally round edge 27 (having a diameter D) including a primary flat 28 (having a length L₁) that is perpendicular, for instance, to the (112̅0) plane. In some instances, the wafer 25 may include a notch instead of a primary flat or may be devoid of both the notch and primary flat.

Methods disclosed herein may be applied to substrates of various crystalline materials, of both single crystal and polycrystalline varieties. In certain embodiments, methods disclosed herein may utilize cubic, hexagonal, and other crystal structures, and may be directed to crystalline materials having on-axis and off-axis crystallographic orientations. In certain embodiments, methods disclosed herein may be applied to semiconductor materials and/or wide bandgap materials. Example materials include, but are not limited to, silicon, gallium arsenide, and diamond.

In certain embodiments, such methods may utilize single crystal semiconductor materials having a hexagonal crystal structure, such as 4H—SiC, 6H—SiC, or Group III-nitride materials (e.g., GaN, AlN, InN, InGaN, AlGaN, or AlInGaN). Various illustrative embodiments described hereinafter mention SiC generally or 4H—SiC specifically, but it is to be appreciated that any suitable crystalline material may be used. Among the various SiC polytypes, the 4H-SiC polytype is particularly attractive for power electronic devices due to its high thermal conductivity, wide bandgap, and isotropic electron mobility. Bulk silicon carbide may be grown on-axis (i.e., with no intentional angular deviation from the c-plane thereof, suitable for forming undoped or semi-insulating material) or off-axis (typically departing from a grown axis such as the c-axis by a non-zero angle, typically in a range of from 0.5 to 10 degrees (or a subrange thereof such as 2 to 6 degrees or another subrange), as may be suitable for forming n-doped or highly conductive material).

Certain embodiments herein may use substrates of doped or undoped silicon carbide, such as silicon carbide boules, which may be grown by physical vapor transport (PVT) or other conventional boule fabrication methods. If doped SiC is used, such doping may render the SiC n-type or semi-insulating in character. In certain embodiments, an n-type silicon carbide boule is intentionally doped with nitrogen. In certain embodiments, an n-type silicon carbide boule includes resistivity values within a range of 0.015 to 0.028 Ohm-centimeters. In certain embodiments, a silicon carbide boule may have resistivity values that vary with vertical position, such that different substrate portions (e.g., wafers) have different resistivity values, which may be due to variation in bulk doping levels during boule growth. In certain embodiments, a silicon carbide boule may have doping levels that vary horizontally, from a higher doping region proximate to a center of the boule to a lower doping level proximate to a lateral edge thereof.

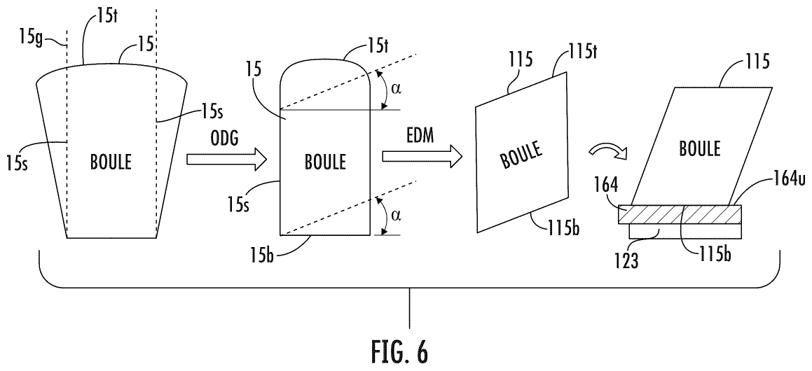

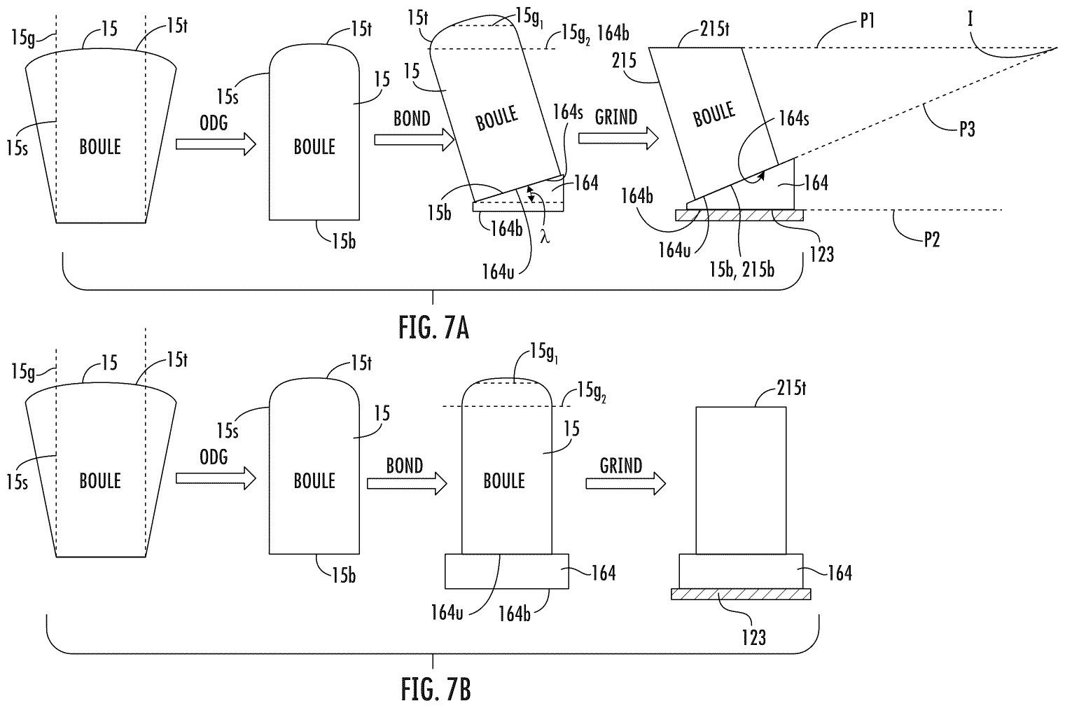

FIGS. 5A and 5C schematically illustrate on-axis and off-axis crystalline substrates in the form of boules that may be utilized with methods disclosed herein. FIG. 5A is a side elevation schematic view of an on-axis boule 15 of crystalline material having first and second end faces 16, 17 that are perpendicular to the c-direction (i.e., <0001> direction for a hexagonal crystal structure material such as 4H-SiC). FIG. 5B is a side elevation schematic view of the boule 15 of FIG. 5A being rotated by four degrees (the angle is enlarged in the figures for case of viewing), with a superimposed pattern 18 (shown in dashed lines) for cutting and removing end portions of the boule 15 proximate to the end faces 16, 17 per the processing method of FIG. 6 or for removing only the top end face 16 per the example processing method of FIG. 7.

FIG. 5C is a side elevation schematic view of an off-axis boule 15A formed from the boule 15 of FIG. 5B, following removal of end portions to provide new end faces 16A, 17A that are non-perpendicular to the c-direction per the processing method of FIG. 6. Aspects of the present disclosure are applicable to both on-axis boules 15 and/or off-axis boules 15A or other on-axis crystalline materials and/or off-axis crystalline materials.

FIGS. 5D and 5E schematically illustrate off-axis grown boules that may be utilized with methods disclosed herein. FIG. 5D is a side elevation schematic view of an off-axis grown boule 15B of crystalline material (e.g., grown from an off-axis seed material) having first and second end faces 16B and 17B that are non-perpendicular to the c-direction (e.g., <0001> direction for a hexagonal crystal structure material such as 4H-SiC). Portions of the boule 15B may be ground or cut along the superimposed pattern 18B (shown in dashed lines) to provide the off-axis boule 15B shown in FIG. 5E. Off-axis semiconductor wafers may be provided from the off-axis boule 15E by separating the wafers from the boule 15B in a manner parallel to the face 16B.

Aspects of the present disclosure are directed to providing semiconductor wafers from any suitable boule, such as an on-axis boule, an off-axis boule, an on-axis grown boule, and off-axis grown boule, a boule grown along other directions or axes (e.g., a-axis, c-axis) or other suitable boule.

Turning now to FIG. 6, a simplified schematic illustration of a method of processing a boule 15 is shown. The boule 15 can be an off-axis or on-axis boule and can have side cut lines 15s typically formed by an outer diameter grind (ODG) workstation followed by electric discharge machining (EDM) workstation whereby electricity is input into a single wire in a water bath to slice the top 15t and the bottom 15b of the boule 15 off at respective cut angles “α” to provide parallel top and bottom end faces of a prepared boule 115. The prepared boule 115 has a bottom surface 115b (which can be interchangeably referred to as a “bottom end” or “bottom end face”). The top 115t of the prepared boule 115 is typically parallel to the bottom 115b. The bottom of the boule 115 can be bonded to a boule-handling carrier 164. The boule-handling carrier 164 can have a bottom surface that is horizontal and that can be held by a vacuum chuck 123 at one or more processing workstations. In certain embodiments, the boule-handling carrier 164 has a planar, horizontal surface that is affixed to the bottom 115b of the boule 115. The boule-handling carrier 164 has sufficient bond strength to remain bonded down to a small remnant of boule even after a number of wafer separation actions, e.g., 10-100 or even more, from the top end 115t of the boule 115 and over a number of grinding and/or polishing actions, at least one between each wafer separation, facilitating wafer separation down to a small thin remnant of the boule 115 (FIG. 15E). That is, the boule 15, 115, 215, for example, can have a remaining thickness or height at the end of boule processing whereby further wafer separation from the remnant ceases, that can be in a range of 100 microns to 500 microns typically about 300 microns. The wafer separation action can be at least partially in response to ultrasound energy applied to the boule 15, 115, 215 to cause a respective wafer to separate at a subsurface damage region while the boule is held by the boule-handling carrier 164.

FIG. 7A is a schematic illustration of another example processing method for a boule 15 which is particularly suitable for an off-axis boule 15 but can be used with any boule 15 to adjust an angle of orientation of the crystal of the boule 15 by using an appropriately angled boule-handling carrier 164. In this example, a (starting) boule 15 can have an outer diameter with sides 15s that angle outward or inward from a top end 15t to a bottom end 15b. The top end 15t may project outward or form a “dome” or other curvilinear shape. The top end 15t (which can be interchangeably referred to as a “top” and a “top end face”) can correspond to a surface that is produced at the end of growth which may be in the form of a dome end face (e.g., an Si-face). The bottom end 15b may be planar. The bottom end 15b (which can be interchangeably referred to as a “bottom” and a “bottom end face”) can correspond to the “seed end” which defines the bottom end face of the crystal and the start of growth (e.g., a C-face). The outer diameter of the boule 15 can be exposed to an outer diameter grind (ODG) workstation whereby the outer perimeter providing the sides 15s (in lateral section views) is ground to be more centered along its length rather than projecting outward from the bottom 15b to a further outward position at the top 15t thereby forming substantially parallel sides 15s in a lateral section view. Thus, the sides 15s can be formed to be vertical and substantially orthogonal to the bottom 15b. The bottom 15b can be bonded to a boule-handling carrier 164 that has an upper surface 164s that faces the bottom 15b of the boule 15. The upper surface 164s of the boule-handling carrier 164 can be an inclined surface that is inclined at an angle of inclination “λ” from horizontal. No EDM is required to cut the bottom 15b to match the top end face angle as discussed with respect to the processing system shown in FIG. 6.

The inclined upper surface 164s of the boule-handling carrier 164 can have an angle of inclination λ from horizontal that can be in a range of greater than 0 degrees to about 20 degrees from horizontal, more typically in a range of 0.5 degrees to about 10 degrees or in a range of about 2 degrees to about 6 degrees. The angle of inclination % (from horizontal) can be, for example, about 0.5 degrees, about 1 degree, about 1.5 degrees, about 2 degrees, about 2.5 degrees, about 3 degrees, about 3.5 degrees, about 4 degrees, about 4.5 degrees, about 5 degrees, about 5.5 degrees, about 6 degrees, about 6.5 degrees, about 7 degrees, about 7.5 degrees, about 8 degrees, about 8.5 degrees, about 9 degrees, about 9.5 degrees, about 10 degrees, about 10.5 degrees, about 11 degrees, about 11.5 degrees, about 12 degrees, about 12.5 degrees, about 13 degrees, about 13.5 degrees, about 14 degrees, about 15 degrees, about 16 degrees, about 17 degrees, about 18 degrees, about 19 degrees and about 20 degrees.

The angle of inclination λ can vary depending on a target boule allowing for customization of boule-handling carrier configurations depending on the particular orientation of support desired for a respective boule 15, which in turn can depend on an angle of the crystal plane of the boule or an orientation of crystalline growth of the material forming the boule or a customer selected angle. For example, if a boule has a 4-degree crystal orientation and a 2-degree wafer is desired, a boule handling carrier 164 with a 2-degree angle of inclination can be coupled to that boule in a direction opposing the 4-degree angle to provide a 2-degree wafer(s).

However, as shown in FIG. 6 and FIG. 7B, in certain embodiments, whether for on-axis boules or off-axis boules, the boule-handling carrier 164 can have an upper surface 164u that is horizontal.

No wafer-handling carrier is required for processing the boule 115, 215 and the top end face adjacent the subsurface damage region can remain bare or devoid of any carrier during respective separation actions. Accordingly, respective wafers can be separated from the top end face side of the boule 115, 215 and provided “bare” or devoid of any carrier affixed thereto for subsequent processing away from the remaining bulk of the boule 115, 215. The remaining bulk of the boule 115, 215 may remain bonded to the boule-handling carrier 164 until the bottom end of the boule 115b, 215b reaches a remnant in thickness/height that precludes further wafer separations (FIGS. 15D, 15E).

Referring again to FIGS. 6, 7A and 7B, the top 15t of the boule 15 can be at least partially planarized at a workstation. The top 15t of the boule 15 can be at least partially planarized by any desired process such as wire cutting, grinding or other material removal process(es) and corresponding equipment.

In certain embodiments, the top of the boule 15t is only partially planarized, to grind level 15g₁ (FIGS. 7A, 7B), for example, and this portion of the boule can be used to provide smaller diameter wafers that can be separated from the top 15t before the boule reaches its maximal outer diameter at which point, the boule can be separated into larger, standardized wafers of substantially constant diameter. For example, one or more wafers having a first diameter can be separated from the top of the boule from a portion of the boule having a height or thickness in a range of about 300 microns, about 20 mmm, about 50 mm, or about 100 mm before the “standard” size planar wafers are separated corresponding to the maximal outer diameter of the boule 15. This partial planarizing can be used to increase yield/decrease sacrificial or waste crystalline material.

Referring to FIG. 7A, after the partial or total planarizing action to respective plane levels 15g₁, 15g₂, for example (e.g., by grinding), the top 215t of the prepared boule 215 can reside in a first plane P1, shown as a horizontal plane, that is parallel to a second plane P2 corresponding to the plane defined by the bottom 164b of the carrier 164 as shown by the rightmost configuration in the sequence of FIG. 7A.

The top 215t of the boule 215 is partially or totally planarized while the bottom 215b of the boule 15, 215 is held by the carrier and at the angle of inclination % of the carrier 164 such that the bottom 215b of the prepared boule 215 is oriented to extend about a third plane P3 which will intersect the first plane P1 at an intersection I that is located a distance outside the boule 215.

The bottom 164b of the boule-handling carrier 164, coupled to the bottom 15b of the “starting” boule 15, can be held by a respective vacuum chuck 123 at the planarizing (e.g., grinding) workstation and/or other workstation used to at least partially planarize the top 215t of the boule 215 and also at one or more subsequent processing workstations for separating wafers from the top end 215t at a subsurface damage region as will be discussed further below.

In certain embodiments, the (starting) boule 15 and the prepared boules 115, 215 can have a generally cylindrical shape and/or may have a height/thickness of at least about one or more of the following thicknesses: 300 μm, 350 μm, 500 μm, 750 μm, 1 mm, 2 mm, 3 mm, 5 mm, 10 mm, 20 mm, 1 cm, 2 cm, 5 cm, 10 cm, 20 cm, 30 cm, or more including any thicknessed between any of the noted example thicknesses, such as thicknesses or “heights” in a range of 1 mm to about 10 cm prior to removing a first wafer therefrom.

In certain embodiment, the boule 15, 115, 215 may comprise a diameter of 0.5 mm or greater, 1 mm or greater, 10 mm or greater, 100 mm or greater, 150 mm or greater, 200 mm or greater, 300 mm or greater or 400 mm or greater. The outer diameter the boule 15, 115, 215 can be in a range of about 70 mm to about 500 mm, more typically in a range of about 100 mm to about 500 mm.

In certain embodiments, the (prepared) boule 115, 215 can be divided into wafers. The wafers can include a thicker wafer that is divisible into two thinner wafers or to thin wafers formed from directly separation from the (dome face/side) of the boule.

In certain embodiments, the wafers can thereafter be processed. For example, one or more epitaxial layers can be formed on a wafer along with one or more metal contacts to provide a device wafer with a plurality of electrically operative devices.

The boules for the processes and devices described herein can be formed of various crystalline materials, of both single crystal and polycrystalline varieties. In certain embodiments, the boules may comprise cubic, hexagonal, and other crystal structures, and may be directed to crystalline materials having on-axis and/or off-axis crystallographic orientations.

As discussed above, in certain embodiments, methods and systems disclosed herein may be applied to boules providing semiconductor materials and/or wide bandgap materials. Exemplary materials include, but are not limited to, Si, GaAs, and diamond. In certain embodiments, such methods may utilize single crystal semiconductor materials having hexagonal crystal structure, such as 4H—SiC, 6H—SIC, or Group III nitride materials (e.g., GaN, AlN, InN, InGaN, AlGaN, or AlInGaN). Various illustrative embodiments described hereinafter mention SiC generally or 4H—SiC specifically, but it is to be appreciated that any suitable crystalline material may be used. Among the various SiC polytypes, the 4H—SiC polytype is particularly attractive for power electronic devices due to its high thermal conductivity, wide bandgap, and isotropic electron mobility.

Bulk SiC may be grown on-axis (i.e., with no intentional angular deviation from the c-plane thereof, suitable for forming undoped or semi-insulating material) or off-axis (typically departing from a grown axis such as the c-axis by a non-zero angle, typically in a range of from 0.5 to 10 degrees (or a subrange thereof, such as of 2 to 6 degrees), as may be suitable for forming N-doped or highly conductive material). Embodiments disclosed herein may apply to on-axis and off-axis crystalline materials, as well as doped and unintentionally doped crystalline materials. Certain embodiments disclosed herein may utilize on-axis 4H—SiC or vicinal (off-axis) 4H—SiC having an offcut in a range of from 1 to 10 degrees, or from 2 to 6 degrees, or about 4 degrees.

### Boule-Handling Carrier Properties

Boule-handling carriers are contemplated for use with various methods for processing boules, and particularly for supporting boules during a number of sequential separating actions. No wafer-handling (top) carrier is required but may optionally be used to facilitate separating wafers therefrom along subsurface (damage) regions.

The boule-handling carriers can be selected to provide the desired durability, structural support and bonding strength to be able to remain bonded and intact structurally through a plurality of different grinding and separating actions that can expose the boule handling carriers to large torsional forces (grinding) and, where used, ultrasound energy at sequential separation events for separating wafers.

Various embodiments refer to a boule-handling carrier that has sufficient rigidity to maintain its shape and remain bonded to the boule without bowing through various processing steps such as grinding and exposure to high frequency ultrasonic energy in the range of about 20-100 KHz, with the ultrasonic energy exposure for a time duration in a range of 10 minutes to about 1 hour, can be used for facilitating wafer separation, in some embodiments.

In certain embodiments, at least a portion of the boule-handling carrier can comprise a modulus of elasticity (a/k/a Young's modulus) of at least about 20 GPa, at least about 50 GPa, at least about 100 GPa, at least about 200 GPa, or at least about 300 GPa. The modulus of elasticity is a mechanical property that measures the stiffness of a solid material. It defines the relationship between stress (force per unit area) and strain (proportional deformation) in a material in the linear elasticity regime of a uniaxial deformation.

Any wafer-handling carrier, where used, may have a similar or different modulus of elasticity from the boule-handling carrier.

For boule-handling carriers 164 coupled to the bottom 115b, 215b of a boule (FIGS. 6, 7A, 7B) for an entire processing cycle of the boule whereby wafers are removed serially over different separation cycles down to a small remaining amount, the boule-handling carrier 164 can be bonded to the bottom 115b, 215b of the boule with sufficient bonding strength to withstand the torsion and other forces applied during different coarse and fine grinding operations applied to the top end face 115t, 215t as various wafers are sequentially separated therefrom during processing, which can include at least 10 different wafer separations, typically at least 100 wafer separations, and may include 100-600 wafer separations from a single boule. The bonding strength of the boule-handling carrier to the boule, which may be provided by a suitable adhesive or which may be adhesiveless, can be at or above about 2500 psi. The bonding strength can be in a range of 2500 psi to about 8500 psi. The bonding strength can be in a range of 2700 psi to about 5000 psi, including about 3400 psi.

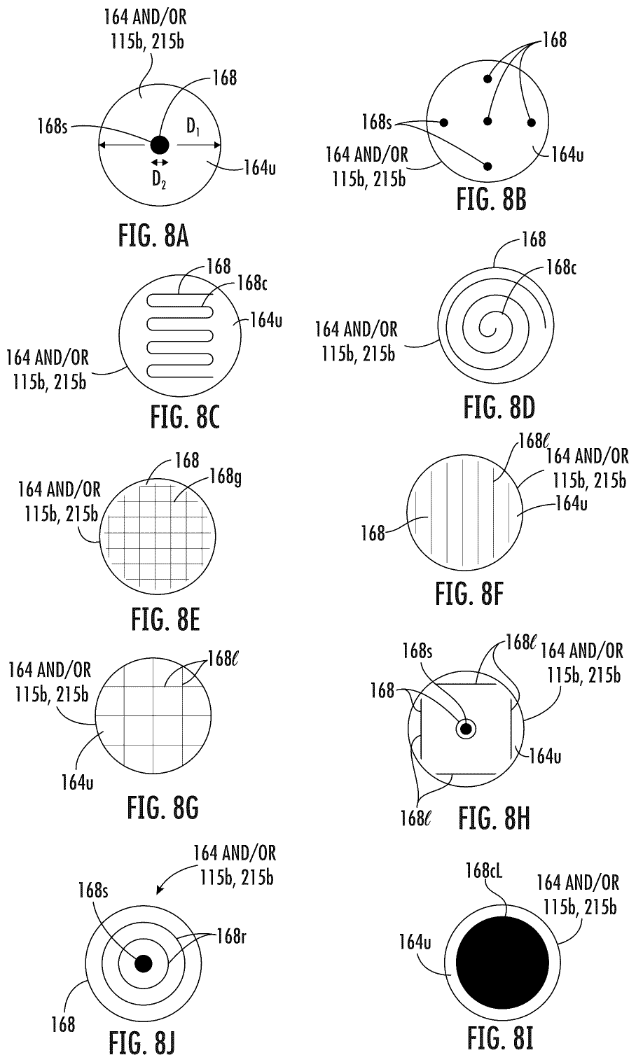

Referring to FIGS. 8A-8J, example adhesive deposition patterns of adhesive 168 used to bond the boule-handling carrier 164 to the boule 15, 115, 215 are shown. The adhesive 168 can be applied to cover a surface area of an upper surface 164u of the boule-handling carrier 164 that is in a range of 0.69% to 100% of the surface area of the bottom of the boule 115b, 215b. Where the boule-handling carrier 164 has the same surface area as the boule 15, 115, 215, the adhesive can cover 0.69%-100% of the surface area of the upper surface 164u of the boule-handling carrier 164. In certain embodiments, the adhesive 168 can be applied to the upper surface 164u of the boule-handling carrier 164. In certain embodiments, the adhesive 168 can be applied to the bottom 115b, 215b of the boule instead of the boule-handling carrier 164. In certain embodiments, the adhesive 168 can be applied to both the bottom 115b, 215b of the boule and the boule handling-carrier 164.

FIG. 8A shows that the adhesive 168 can be provided as only a medially located spot 168s with a lateral extent D2 that is less than 10% of a maximal lateral extent D1 (diameter when provided as a cylinder) of the boule-handling carrier 164 and/or boule bottom 115b, 215b. FIG. 8B shows the adhesive 168 can be provided as a plurality of spots 168s including a medial spot and a plurality of spaced apart spots arranged closer to an outer edge portion of the carrier 164 or boule bottom 115b, 215b. The spots 168s can be arranged in a symmetric or asymmetric pattern. FIG. 8C shows the adhesive 168 arranged in a curvilinear pattern 168c arranged in a spiral configuration. FIG. 8D shows the adhesive 168 arranged in a curvilinear pattern 168c arranged in a coil configuration. FIG. 8E shows the adhesive 168 arranged in a grid 168g of lines 168/that cross. FIG. 8F shows the adhesive 168 in lines 168/that do not cross and that are substantially parallel. FIG. 8G shows the adhesive 168 with lines 168/with more linear lines in one direction than another whereby the other linear lines cross the linear lines away from the center of the boule-handling carrier 164 and/or the bottom of the boule 115b, 215b. FIG. 8H shows the use of both at least one spot 168s and lines 1681. FIG. 8I shows the adhesive applied as a continuous layer 168cL to cover the portion of the boule-handling carrier 164 that abuts the boule bottom 115b, 215b and/or to cover the entire bottom surface of the bottom of the boule 115b, 215b. FIG. 8J shows that the adhesive 168 can be provided as concentric rings 168r with (or without) a center spot 168s. The adhesive 168 can be directly applied as a fluid, mist, liquid, paste, gel or other composition/physical state. The adhesive 168 can be applied as a double-sided tape in any suitable pattern.

Example boule-handling carriers 164 can comprise silicon, silicon carbide, plexiglass, bullet-proof glass, quartz or borosilicate glass.

In certain embodiments, the boule-handling carrier 164 can be ultraviolet light transparent.

In certain embodiments, the boule-handling carrier 164 can be a borosilicate glass such as a floated borosilicate flat glass. An example floated borosilicate flat glass is BOROFLOAT® borosilicate glass from SCHOTT, having a place of business as SCHOTT North America in Louisville, Kentucky.

In some embodiments, when a boule-handling carrier 164 is to be bonded to a boule with an adhesive, in certain embodiments the boule-handling carrier may comprise generally semiconductors, inorganic materials, metals, metalloids, non-metals, ceramics, crystalline materials (e.g., single crystal or polycrystalline in character), amorphous materials, polymeric materials, glasses, and composite materials. In certain embodiments, a boule-handling carrier may comprise two or more material that are bonded or joined together by various conventional means. Other materials may be used, as will be recognized by one skilled in the art.

In certain embodiments, a boule-handling carrier is not necessarily adhesively bound to a boule and may comprise single crystal materials (e.g., single crystal or polycrystalline in character), semiconductor materials, ceramic materials, metalloids, inorganic materials, fiber reinforced resins and composite materials.

In certain embodiments, a boule-handling carrier 164 may have a maximum and/or minimum thickness of at least 500 μm, greater than 800 μm, at least 850 μm, at least 900 μm, at least 1 mm, at least 1.5 mm, at least 2 mm, or at least 3 mm, with the preceding ranges optionally bounded by upper limits of 1 mm, 2 mm, 3 mm, 4 mm, or 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, about 25 mm or even greater, as appropriate.

In certain embodiment, a boule-handling carrier 164 may have a minimum and/or maximum thickness in a range of from about 0.5 mm to about 25 mm, a range of about 0.5 mm to about 10 mm, a range of about 6 mm to about 25 mm, a range of about 1 mm to about 10 mm, or a range of about 6 nm to about 10 mm.

Referring to FIG. 10, in certain embodiments, the boule-handling carrier 164 can have a maximal thickness T1 and a minimal thickness T2, where T1>T2. In some embodiments, T2 can be 0.1× minimum of T1 (e.g., if the maximal thickness T1 is 10 mm, T2 can have a minimal thickness of 1 mm). In some embodiments, T2 can have a maximum thickness that can be about 0.95×T1 (e.g., if T1 is 25 mm, T2 can be about 23.75 mm).

In certain embodiments, the boule handling carrier 164 may desirably have a lateral extent (e.g., diameter, or length and width) that is at least as large as, or that exceeds (FIGS. 6, 7A, 7B), corresponding dimensions of a boule bonded thereto.

In certain embodiments, at least one of a maximum length or maximum width of at least a portion of the boule-handling carrier exceeds a corresponding maximum width than the boule at least on one side thereof, typically a larger surface area of the boule. In certain embodiments, at least a portion of the at least one edge of the boule-bonding carrier may extend laterally at least about 100 microns, at least about 200 microns, at least about 500 microns, at least about 1 mm, or at least about 2 mm, such as 2 mm-5 cm beyond the corresponding at least one outermost edge of the boule. In certain embodiments, at least one of the boule handling carrier 164 and/or the boule 15, 115, 215 can include a respective notch or flat 164F, 124 (FIG. 14B) along the at least one outer edge thereof. At least a portion of the boule-handling carrier 164 can extend laterally beyond the notch or flat 124 of the boule 15, 115, 215. The notches or flats 124, 164F can provide an orientation indicator or other processing information.

Embodiments including only the boule-handling carrier and embodiments of dual carriers using both a boule-handling carrier and a wafer-handling carrier are disclosed herein.

As discussed above, a wafer-handling carrier can be arranged proximal to a subsurface damage region, as distinguished from the boule-handling carrier arranged on a bottom of the boule and distal from a wafer-handling carrier, where used. Again, according to certain embodiments disclosed herein, no wafer-handling carrier is required. Where used, a wafer-handling carrier can be configured to promote separation of crystalline material along or proximate to a subsurface damage region.

According to certain embodiments disclosed herein, the boule-handling carrier 164 can be configured to direct ultrasound energy into the boule to promote wafer separation, which is particularly useful as the boule becomes thinner (see, FIG. 15E). As boules to be separated into wafers get thinner (e.g., below about 5 mm in thickness), a boule-handling carrier 164 can be particularly useful as it adds mass to the bonded assembly to distribute ultrasonic energy into the bonded assembly and therefore the facture region of the wafer separation region which is closer to the boule-handling carrier at a remaining/remnant boule thickness of under about 5 mm.

In some embodiments, when a wafer-handling carrier is used and there is a coefficient of thermal expansion (CTE) mismatch between the wafer-handling carrier and boule that is used to promote fracture of a substrate along a subsurface damage region, the boule-handling carrier may have a different CTE from the wafer-handling carrier.

In certain embodiments, the boule-handling carrier may have less CTE mismatch against the boule than a wafer-handling carrier, where used. In certain embodiments, the boule-handling carrier may be CTE matched or nearly CTE matched to a respective boule.

In certain embodiments, the boule-handling carrier may be CTE mismatched or have the same CTE mismatch as any wafer carrier, if used.

In certain embodiments, when used, the wafer-handling carrier having a first coefficient of thermal expansion or CTE₁ can be bonded or joined to a surface of a boule of crystalline material having subsurface damage and having a second coefficient of thermal expansion or CTE₂, wherein CTE₁>CTE₂ at a desired temperature (e.g., at 25° C.) or over a desired temperature range. Thereafter, at least the wafer-handling carrier can be cooled, causing the carrier to shrink in size more rapidly than the crystalline material due to the CTE differential. Such differential shrinkage creates stress (e.g., shear stress) in the wafer-handling carrier as well as the crystalline material, and such stress causes the crystalline material to fracture along the subsurface laser damage region.

CTE may vary with temperature for various materials. For a rigid carrier having a CTE greater than that of a crystalline material, in certain embodiments, the boule-handling carrier and/or the wafer-handling carrier may comprise a material having a CTE that is greater than a CTE of the crystalline material at a desired temperature (e.g., at 25° C., at 100° C., at 200° C., at 300° C., at 0° C., and/or −100° C.), or over a desired temperature range (e.g., a range of −100° C. to 300° C., a range of −100° C. to 200° C., a range of from −100° C. to 100° C., a range of from 0° C. to 200° C., a range of from 50° C. to 150° C., or any other suitable temperature range or subrange disclosed herein).

In certain embodiments, a CTE of a wafer-handling carrier, where used (to be arranged proximate to a subsurface damage region in a crystalline material substrate), can be less than 5 times, no more than about 4 times, no more than about 3 times, no more than about 2 times, no more than about 1.5 times greater than the CTE of the boule (crystalline material substrate). In certain embodiments, the CTE of a wafer-handling carrier is greater than the CTE of the crystalline material substrate (boule) by a multiplication factor in a range of from about 1.25 to about 4. Some or all of the foregoing CTE mismatch ratios believed to be significantly smaller than CTE mismatch ratios for materials used in conventional nickel-or polymer-based spalling (separation) techniques (such as described in the background portion of the present disclosure). For example, a CTE mismatch ratio between nickel or nickel-containing metals (useable as a wafer-handling carrier) and SiC (useable as a crystalline material) may be at least 5 or more, and a CTE mismatch ratio between polymers and SiC may be on the order of 10 to 100 or more.

In certain embodiments, a boule of crystalline material having subsurface damage may be arranged between boule-handling and wafer-handling carriers. In such embodiments, the wafer-handling carrier is joined to a first surface of the boule proximate to the subsurface damage, and the boule-handling carrier is joined to a second surface of the crystalline material that opposes the first surface and is distal from the subsurface damage.

In certain embodiments, the wafer-handling carrier and the boule handling carrier may both have CTE values that exceed the CTE of the crystalline material. In other embodiments, the wafer-handling carrier can have a CTE greater than a CTE of the crystalline material, while the boule-handling carrier can have a CTE that is less than or equal to a CTE of the crystalline material.

In certain embodiments, no wafer-handling carrier is used and the boule-handling carrier can have a CTE that is greater, the same or less than the boule. Where the CTE is greater, it may be selected to promote debonding of the boule-handling carrier from the boule.

In certain embodiments, a wafer-handling carrier, where used, for a SiC substrate may be sapphire, which exhibits significant CTE mismatch relative to SiC, while the boule-handling carrier can be SiC having no mismatch relative to the SiC boule.

### Bonding or Joining of Boule-Handling Carrier to Crystalline Material

Various methods may be used to bond or join a boule-handling carrier to a target surface of a boule of crystalline material. One method includes adhesive bonding, which may involve application of adhesive material to a target surface of the boule-handling carrier 164 as discussed above with respect to FIGS. 8A-8I, then mating the adhesive 168 with a target surface of a crystalline material, and curing the adhesive (e.g., by subjecting the carrier/adhesive/crystalline material stack to curing parameters such as one or more of UV light, IR light, visible light, elevated temperature, and/or compression or pressure between the boule handling carrier and the boule with the adhesive therebetween). In certain embodiments, the adhesive 168 can be applied to the boule 15, 115, 215 instead of the boule-handling carrier 164. In certain embodiments, the adhesive 168 can be applied to both the boule 15, 115, 215 and the boule-handling carrier 164. Applying to only the boule-handling carrier 164 can reduce the handling of the boule.

In certain embodiments, bonding between the boule-handling carrier and the boule of crystalline material may be temporary in character, such as by using an adhesive material that will maintain adhesion during certain conditions (e.g., room temperature and during processing operations) but will exhibit reduced adhesion during removal conditions (e.g., at temperatures sufficient to cause the adhesive material to flow, and/or in exposure to a chemical agent configured to weaken or dissolve the adhesive material). The use of temporary bonding media permits the boule of crystalline material to be bonded to the boule-handling carrier for processing for sequential separation events according to methods disclosed herein (e.g., thermal-induced fracture at low temperature, fracture induced by application of mechanical force, and/or fracture induced by application of ultrasonic energy), but permits remaining/remnants of crystalline material adhered to the boule-handling carrier to be removed after the performance of processing steps to/on the boule of crystalline material portion while attached to the boule-handling carrier.

Desirable properties for adhesive materials useable with various embodiments of the present disclosure may depend in part on a number of grinding operations and/or wafer separations which can apply various loads and degradation exposures to the boule.

The boule-handling carrier can remain coupled to the boule until the remnant end size and then be debonded, cleaned and reused a number of times for different boules over a respective boule-handling carrier life. While not required for processing or separations, the wafer-handling carrier, where used, can be reused for different separations of wafers from the same boule. The boule-handling carrier can remain attached to a single boule for sequential wafer separation actions, such as 10-100 or more such wafer separations, and intervening grinding, polishing and/or other processing operations down to a small remnant of boule.

With respect to bonding or cohesive strength, a desirable adhesive material should have cohesive strength that is sufficiently high for the adhesive material to maintain its integrity and not come apart when subjected to forces at one or more intervening processing operations, such as grinding, polishing and/or other operations for each separation/grinding cycle for each wafer removed.

In certain embodiments, an adhesive material may comprise an adhesive that is compatible with compression adhesive bonding.

In certain embodiments, the adhesive can be provided by a two-sided tape to couple the boule-handling carrier 164 and boule 15, 115, 215.

In certain embodiments, an adhesive material may comprise an adhesive that is curable with ultraviolet (UV) light and the boule-handling carrier 164 can be ultraviolet light transmissive. The UV light can be applied while pressing the boule-handling carrier 164 against the boule 15, 115, 215.

In certain embodiments, the boule and boule-handling carrier 164 with the adhesive can be debonded at temperatures in a range of 90 degrees F. to 1000 degrees F., preferably in a range of 140 degrees F. to 250 degrees F., and more preferably in range of 200 degrees F. to 250 degrees F. The grinding operations can expose the boule-handling carrier 164 to elevated temperatures but the adhesive does not debond as the boule-handling carrier 164 and/or the interface of the boule-handling carrier 164 and bottom of the boule 15b, 115b, 215b with the adhesive therebetween can be cooled using fluid such as water to actively cool the interface during grinding.

Taking into account different adhesive bonding and/or curing processes, in certain embodiments, an adhesive material may have a melting point of greater than 50° C., greater than 100° C., greater than 150° C., or greater than 200° C.

In certain embodiments, an adhesive material may comprise a thermoplastic adhesive. At least certain thermoplastic adhesives may exhibit desirable mechanical and adhesion properties (relatively high T_{g}, high modulus of elasticity, high cohesive strength, high adhesion strength to desirable carriers and crystalline materials, and hardness at the desired temperature ranges (e.g., proximate to room temperature), while still being easily removable when heated to an elevated temperature and/or exposed to solvents.

Other adhesives beyond the thermoplastic materials described hereinabove may be used, as will be recognized by one skilled in the art following review of the present disclosure.

In certain embodiments, an adhesive material may comprise a chemically crosslinked adhesive, such as an epoxy. In certain embodiments, a multi-part, reactive catalyst-type bonding agent (e.g., a two-part epoxy) may be used to join a boule-handling carrier to a boule of crystalline material.

In certain embodiments, the boule-handling carrier 164 (FIGS. 6, 7A, 7B) can be ultraviolet transmissive or transparent, such as quartz or a borosilicate glass, and bonded using a two-part epoxy to a bottom end 15b, 115, 215 of the boule 15, 115, 215 (FIGS. 6, 7A, 7B). An example two-part epoxy with resin and a hardener, such as a temporary two-part epoxy adhesive is VALTRON® or AD4500 from Valtech Corporation, Pottstown, PA. which can be debonded for reuse at the remnant state of the boule, using elevated temperatures such as temperatures in a range of 90° C. to 100° C.

Considering the existence of different types of adhesives that may be used for joining a boule-handling carrier and a boule, various adhesive bonding methods may be employed. In certain embodiments, thermocompression (involving application of compressive force at an elevated temperature above room temperature or at room temperature) may be used. In one example, a force of 100 to 3000 N may be applied to a 150 mm-200 mm diameter crystalline material substrate (e.g., 4H SiC) affixed by adhesive to a carrier during exposure to a temperature of room temperature or above room temperature.

In certain embodiments, compressive force may be applied during impingement of UV emissions on a UV-curable adhesive material between a boule-handling carrier and a crystalline material substrate. When liquid or flowable bond media is used, in certain embodiments the bond media may extend partially up sidewalls of a boule of crystalline material (and along a proximal surface of a carrier) upon squeeze-out during bonding to form a peripheral lip around at least a portion (or an entirety) of a perimeter of a crystalline material, wherein such peripheral lip may serve to slightly increase bond strength between the boule and the carrier.

In certain embodiments, plasma activated anodic bonding or any other suitable anodic bonding process may be used to bond a boule-handling carrier and a boule of crystalline. Details concerning example anodic bonding between crystalline material substrates and carriers are disclosed in U.S. Patent Application Publication No. 2016/0189954, with the contents of such publication hereby being incorporated by reference herein, for all purposes.

In certain embodiments, to facilitate adhesion, target surfaces of a boule-handling carrier and/or a boule of crystalline material may be roughened, patterned, textured, and/or surface activated by any suitable methods prior to bonding (e.g., including adhesive bonding). Examples of surface treatments that may be performed include, but are not limited to, micropatterning, mechanical abrasion, chemical etching, reactive ion etching, and plasma treatment. In certain embodiments, a boule-handling carrier and/or a wafer-handling carrier may include UV transmissive or UV transparent material having a micropatterned surface.

In certain embodiments, a boule-handling carrier may include one or more features configured to facilitate de-bonding when it is desired to remove crystalline material adhered to the carrier. Examples of such features may include perforations and/or micropatterned surfaces to provide holes or cavities arranged proximate to, and/or permitting fluid communication with, an adjacent surface of a carrier or boule of crystalline material.

Various processes may be used to promote de-bonding between a (previously parted or remaining end) portion of crystalline material and the boule-handling carrier. In certain embodiments, thermal, mechanical, chemical, and/or photonic de-bonding may be employed.

In certain embodiments, de-bonding may be performed by thermal slide-off, which involves heating of an adhesively bound assembly to a temperature sufficient to cause adhesive material to soften and/or flow, while the boule-handling carrier is fixed in place (e.g., held by a vacuum chuck) and external shear stress may be applied to the portion of crystalline material to cause the portion to slide laterally away from the carrier.

In certain embodiments, an adhesive may contain a UV-absorbing material, whereby impingement of UV emissions on the adhesive after parting may be used to cause degradation (e.g., by heating) of adhesive between a crystalline material portion and a carrier, permitting the crystalline material portion to be removed. In certain embodiments, heat alone or exposure to infrared light can be used to facilitate the de-bonding. In some embodiments, chemical removal of adhesive may utilize any suitable chemical agent(s) sufficient to reduce adhesion and/or dissolve an adhesive material. If chemical de-bonding is used, then one or more access openings (e.g., perforations) may be provided in the boule-handling carrier to provide a pathway for the chemical(s) to contact the adhesive material.

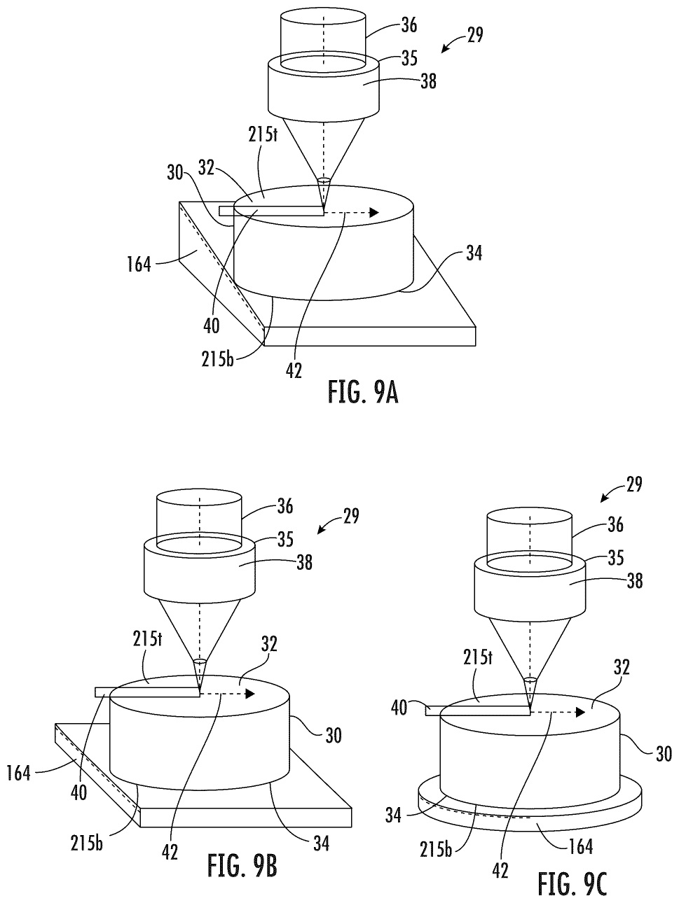

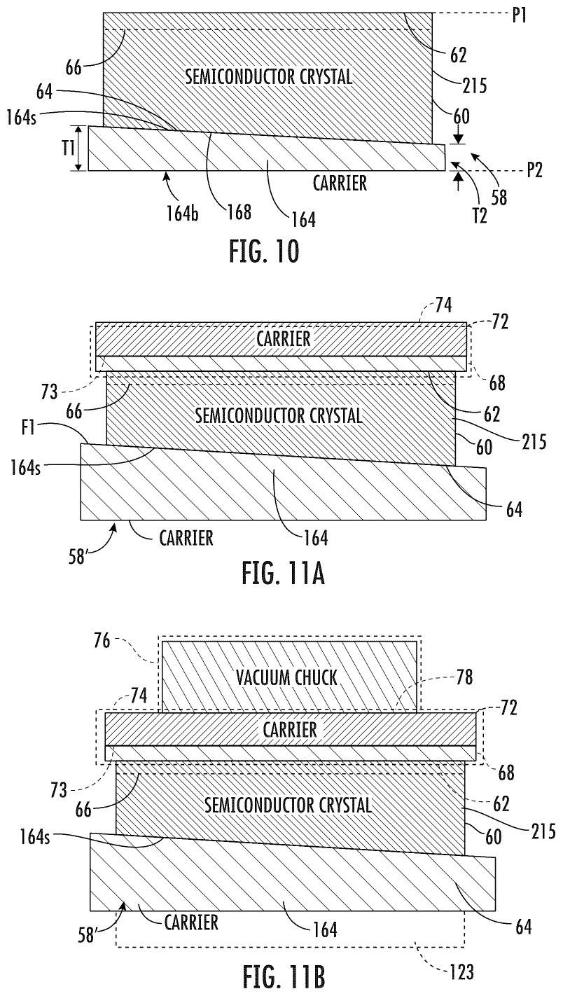

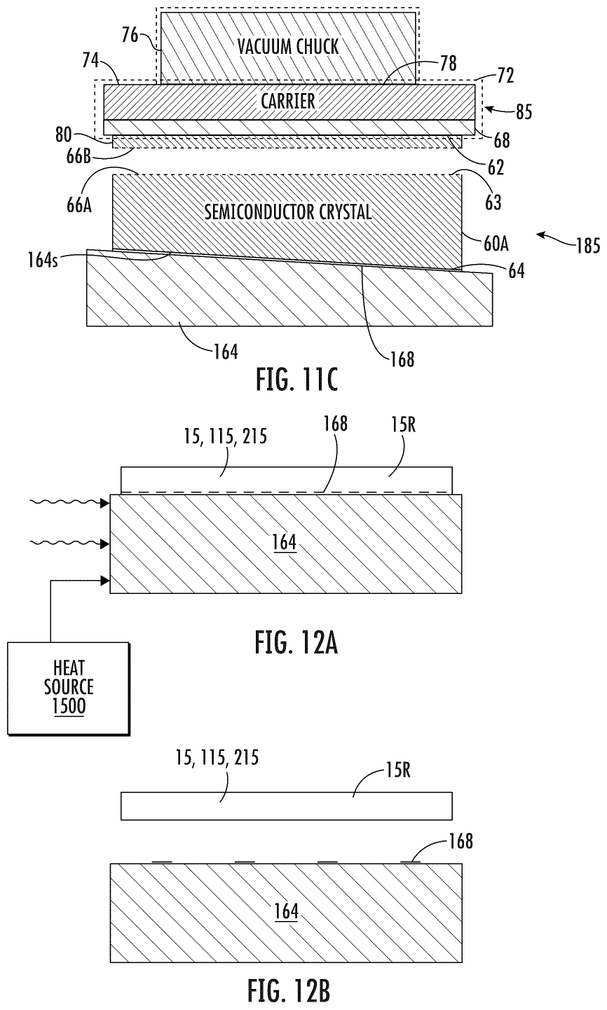

FIGS. 9A-9C are perspective schematic views of one example of a laser tool 29 configured to focus laser emissions within an interior of a boule 215 of crystalline material 30 to form subsurface damage 40. The crystalline material 30 includes an upper surface 32 (top 215t) and an opposing lower surface 34 (bottom 215b) held on a surface of a carrier 164, and the subsurface damage 40 is formed in the interior of the crystalline material 30 between the upper and lower surfaces 32, 34. FIG. 9A shows the attached surface of the boule-handling carrier 164 being an inclined surface. FIGS. 9B and 9C show the attached surface of the boule-handling carrier 164 being horizontal. FIGS. 9A and 9B show the boule-handling carrier 164 having a rectangular body. FIG. 9C shows the boule handling carrier 164 having a cylindrical/disk shaped body. The boule handling carrier 164 can be provided with any suitable shape to work with desired and/or off the shelf vacuum chucks during the manufacturing process thus avoiding costs for custom vacuum chuck configurations.

Although the subsurface damage is shown as created by a laser, this is an example only, other subsurface damage creating techniques may be used, such as, but not limited to, ion implantation. If the crystalline material comprises SiC, the upper surface 32 through which laser emissions are directed, the upper surface may be a C-terminated surface. Laser emissions 36 are focused with a lens assembly 35 to yield a focused beam 38, with a focal point thereof being in the interior of the crystalline material 30. Such laser emissions 36 may be pulsed at any suitable frequency (typically in the nanosecond, picosecond, or femtosecond range) and beam intensity, with a wavelength below the bandgap of the crystalline material 30 to permit the laser emissions 36 to be focused at a targeted depth below a surface thereof. At the focal point, the beam size and short pulse width results in an energy density high enough to result in very localized absorption that forms subsurface damage. One or more properties of the lens assembly 35 may be altered to adjust a focal point of the focused beam 38 to a desired depth within the crystalline material 30. Relative lateral motion (e.g., lateral translation) between the lens assembly 35 and the crystalline material 30 may be affected to create the subsurface damage 40, as schematically illustrated by dashed line 42. Such lateral movement may be repeated in various patterns. However, it is noted that other wafer-forming technology may be used such as ion implantation, for example.

In certain embodiments, a method of processing a boule of crystalline material as disclosed herein may include some or all of the following items and/or steps. A boule-handling carrier 164 may be attached to a backside or bottom side of a boule of crystalline material (e.g., ingot). Thereafter, a top side of the boule is planarized, then ground or polished, such as to provide an average surface roughness Rₐ of less than about 5 nanometers to prepare the surface for transmitting laser energy, preferably the average surface roughness is in a range of 0.2-2 nm Rₐ. Laser damage may then be imparted at a desired depth or depths within the crystalline material substrate, with spacing and direction of laser damage traces optionally being dependent on crystal orientation of the crystalline material substrate. A wafer-handling carrier can be optionally bonded to the top side of the boule. An identification code or other information linked to the boule-handling carrier 164 is associated with one or more wafers to be derived from the boule of crystalline material. Laser marking may be applied to a respective wafer (or one or both carriers, where two carriers are used) prior to separation to facilitate traceability of the wafer during and after fabrication. The boule of crystalline material is then fractured (using one or more methods disclosed herein) along a subsurface damage region to provide separate a slice or wafer with the remainder of the boule bound to the boule-handling carrier, and the separated slice or wafer optionally bound to the wafer-handling carrier. Both the separated portion of the crystalline material and the remainder of the boule can be ground smooth and cleaned as necessary to remove residual subsurface damage. The separated slice or wafer of the crystalline material may be separated from the wafer-handling carrier if used/bound thereto. Thereafter, the process for actions after the bonding of the boule-handling carrier may be repeated for the remainder of the boule bonded to the boule-handling carrier to separate additional slices or wafers down to a thin remnant of the boule.

FIG. 10 is a side cross-sectional schematic view of an assembly 58 including a boule 215 of crystalline material 60 having subsurface damage 66 joined to a boule-handling carrier 164 with the inclined surface 164s (“inclined boule-handling carrier”) with an intermediately arranged layer of adhesive material 168 between the inclined surface 164s and the boule bottom end 64.

The assembly 58 is suited to promote removal of a portion of the crystalline material 60 along the subsurface damage 66 by fracturing the crystalline material 60 along the subsurface damage 66 utilizing any or more methods known to those of skill in the art including those discussed herein. The crystalline material 60 includes a first (top end) surface 62 and an opposing second (bottom end) surface 64, with the subsurface damage 66 being closer to the first surface 62 than to the second surface 64. The first (top end) surface 62 can remain exposed and devoid of any wafer-handling carrier for removal of wafers therefrom.

The inclined surface 164s of the boule-handling carrier 164 is joined to the second (bottom end) surface 64 of the boule 215.

As discussed above, in certain embodiments, the boule-handling carrier 164 can have a maximal thickness T1 that is greater than a minimum thickness T2 thereof.

As also discussed above, the boule-handling carrier 164 can remain bonded to the bottom end 64 throughout the processing of the boule 215 down to a small/thin remainder of the boule 15R (FIG. 12A) after a number of wafers have been separated from the opposing (top) end face 62.

Fracturing with Boule-Handling Carrier Attached to Boule

FIGS. 11A-11C illustrate example steps of a semiconductor processing method according to an embodiment of the present disclosure utilizing boule-handling carrier 164 joined to a boule 215 of crystalline material 60 and showing the wafer handling carrier as an optional feature (shown in broken line to indicate the optional components). FIG. 11A is a cross-sectional schematic view of that includes an assembly 58′ including the optional wafer-handling carrier 72 and adhesive material 68 joined to a boule 215 of crystalline material 60 having a subsurface damage region 66 therein. As shown, the wafer-handling carrier 72 has a greater diameter or lateral extent than the crystalline material 60. The assembly 58′ of FIG. 11B is similar to the assembly 58 shown in FIG. 10 with the boule-handling carrier 164 attached to the boule 215 and (orientation) fiducial F1 visually exposed. The boule-handling carrier 164 can be provided as an inclined carrier 164 and the FIG. 11A shows the boule 215 can optionally be concurrently coupled to the wafer handling carrier and the boule handling carrier 72, 164, respectively, during some processing steps. Typically, the boule-handling carrier 164 is attached to the boule prior to any attachment of the optional wafer-handling carrier 72 and remains bonded to the boule during processing down to the remnant as discussed above.

With continued reference to FIG. 11A, the crystalline material 60 includes a first (top end) surface 62 proximate to the optional adhesive material 68 and includes an opposing second (bottom end) surface 64, with the subsurface damage 66 being closer to the first surface 62 than to the second surface 64 of the crystalline material 60. The optional wafer-handling carrier 72 also includes a first surface 73 proximate to the adhesive material 68, such that the optional adhesive material 68 extends between the first surface 62 of the crystalline material 60 and the first surface 73 of the optional wafer-handling carrier 72. The adhesive material 68 may be cured according to the requirements of a selected bonding method (e.g., high temperature thermocompression adhesive bonding, compression-aided UV bonding, chemically reactive bonding, etc.). The boule-handling carrier 164 is bonded (either temporarily or permanently) to the second (bottom end) surface 64 of the boule 215 of the crystalline material 60, with the inclined surface 164s of the boule-handling carrier 164 facing the second surface 64 of the boule 215. The boule-handling carrier 164 can be wider than the boule 215, can be less wide, or can be coextensive with the width and length of the boule 215. The boule-handling carrier 164 can be CTE matched or CTE mismatched with the crystalline material 60.

FIG. 11B is a cross-sectional schematic view of the assembly 58′ of FIG. 11A, following positioning of the second surface 74 of the wafer-handling carrier 72 on a support surface 78 of an optional cooling apparatus in the form of an optional cooled chuck 76 configured to receive a cooling liquid. The boule-handling carrier 164 can be held by a vacuum chuck 123. Contact between the wafer-handling carrier 72 and the cooled chuck 76 causes heat to be transferred from the wafer-handling carrier 72 to the cooled chuck 76 such that the wafer-handling carrier 72 is cooled rapidly. During such cooling process, the wafer-handling carrier 72 can laterally contract to a greater extent than the crystalline material 60, thereby exerting shear stress on the crystalline material 60. Due to the presence of subsurface damage 66 near the adhesive layer 68 that joins the wafer-handling carrier 72 to the crystalline material 60, the exertion of shear stress on the substrate 60 causes the crystalline material to fracture along or proximate to the subsurface damage region 66.

In certain embodiments, the cooled chuck 76 has a smaller diameter than a diameter of the wafer-handling carrier 72. Cooling of the assembly of FIG. 11B may be applied from the second surface 74 of the wafer-handling carrier 72 and may only be applied over a central portion of the wafer-handling carrier 72, to create a temperature differential both laterally (i.e., from center to edge) and vertically (i.e., from the crystalline material 60 to the first carrier 72). Although the cooled chuck 76 may be supplied with a cooling liquid, it is not necessary for the wafer-handling carrier 72 to reach a cryogenic temperature, e.g., a liquid nitrogen temperature (−160° C.) to successfully complete thermal-induced fracture of the crystalline material 60. Separation for fracturing single SiC material supported by a crystalline sapphire substrate using a cooled chuck can be carried out at a temperature of about −70° C. Such temperature can be maintained using various cooling liquids, such as liquid methanol (which remains flowable above its freezing point at −97° C.) received from a two-phase pumped evaporative cooling system. Separation by cooling the wafer-handling carrier, adhesive, and a substrate in a freezer maintained at −20° C. can occur, wherein such temperature may be maintained using a single-phase evaporative cooling system. The ability to use a single-phase evaporative cooling system or a two-phase pumped evaporative cooling system rather than liquid nitrogen can significantly reduce operating costs. However, other wafer separating methods can be used and a wafer-handling carrier and cooling chuck are not required.

FIG. 11C is a cross-sectional schematic view of a bonded assembly 185 formed by the (bulk) remainder of the boule with the remainder of the crystalline material 60A, the adhesive 168 and the boule-handling carrier 164, separated from the p[topma; bonded assembly 85 (shown separated and positioned atop the liquid-cooled chuck 76) that includes the wafer-handling carrier 72, adhesive material 68, and a portion of the crystalline material 80 removed from the remainder of the boule of crystalline material 60A, following fracture of the crystalline material along the subsurface damage region 66. The remainder of the crystalline material 60A is bounded by a new first surface 63 (having residual damage 66A) that opposes the second surface 64 which remains bonded to the boule-handling carrier 164. Correspondingly, the removed (slice/wafer) portion of crystalline material 80 is bounded by a new second surface 82 (having residual damage 66B) that opposes the first surface 62. Thereafter, the optional bonded assembly 85 including the wafer-handling carrier 72, the adhesive material 68, and the removed portion of crystalline material 80 may be withdrawn from the cooled chuck 76.

The bonded assembly 185 beneficially provides mechanical support for the remainder of the crystalline material 60A to permit one or more surface processing steps (e.g., grinding, polishing, etc.) to be performed on the new surface 63, to remove the residual damage 66A via grinding and/or various rough and fine grinding and/or polishing steps.

Maintaining the removed portion of crystalline material 80 attached to the wafer-handling carrier 72 provides mechanical support for the removed portion of crystalline material 80 to permit one or more surface processing steps (e.g., grinding, polishing, etc.) to be performed on the new surface 82, to remove the residual damage 66B and achieve a desirable thickness of the crystalline material 80 (e.g., via grinding, optionally followed by chemical mechanical planarization (CMP) and/or various polishing steps). In certain embodiments, residual damage removal and thinning may include sequential grinding/polishing operations with a 2000 grit polishing pad and a 7000 grit polishing pad, and any suitable polishing and cleaning steps to prepare the new surface 82 for subsequent operations (e.g., surface implantation, laser marking (e.g., proximate to a wafer flat), formation of epitaxial layers, metallization, etc.).

Turning now to FIGS. 12A and 12B, the boule-handling carrier 164 can be debonded from a remnant of boule 15R by applying heat from a heat source 1500 to the boule-handling carrier 164. The heat source 1500 can be an oven, heat gun, hot plate, IR light, or other suitable device that applies sufficient heat to debond the boule-handling carrier 164 from the boule remnant 15R. The heat source 1500 can apply heat in a temperature range of about 90 degrees F. to about 1000 degrees F., including temperatures in a range of 140 degrees F. to about 250 degrees for about 200 degrees F. to about 250 degrees F.

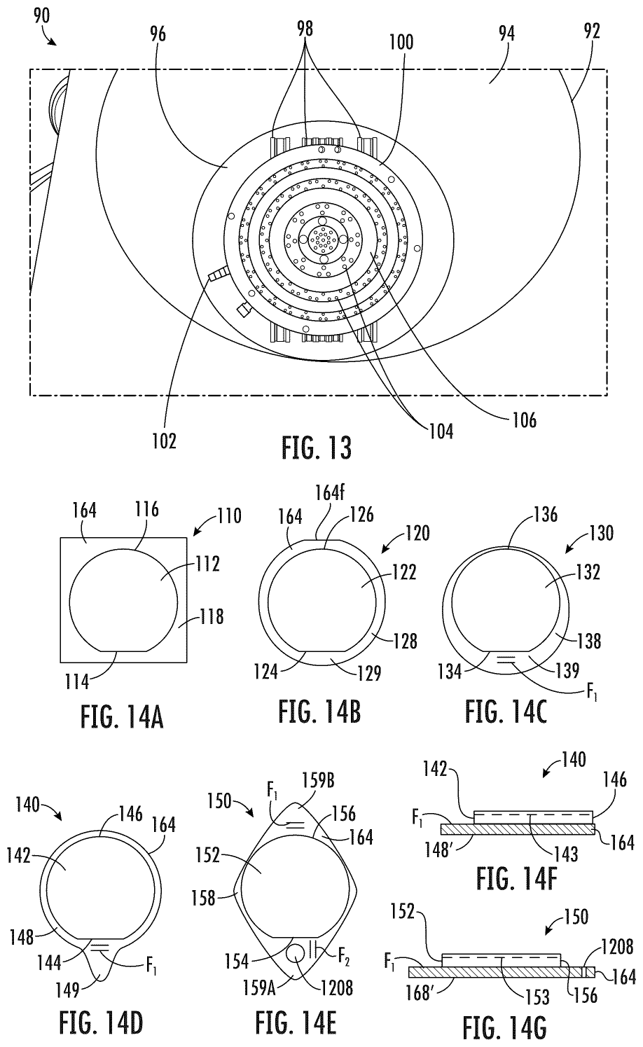

FIG. 13 is a perspective view illustration of a cooling apparatus 90 including a vessel 92 having a cylindrical sidewall 94 bounded by a bottom wall 96, with a chuck 100 supported above the bottom wall 96 by thermally conductive spacer 98 (e.g., aluminum rails). Although the chuck 100 is of a type sufficient for applying suction to a workpiece, the vacuum suction functionality (provided by suction port 102 configured to be connected to a vacuum source, and perforations 104 arranged along a chuck upper surface 106) need not be provided during a cooling operation. In use, a cooling liquid may be supplied to the vessel 92 to contact the spacers 98 but not necessarily an entire width of the chuck 100 itself. Heat may be transferred from the chuck 100 through the thermally conductive spacers 98 to the cooling liquid. In experiments, a vacuum chuck 100 according to the illustrated design has been maintained at a temperature around −70° C. The wafer-handling carrier side of an assembly 58′ as shown in FIG. 11B may be placed on the chuck upper surface 106 to cause the carrier to be rapidly cooled. Due to CTE mismatch between the carrier and the crystalline material substrate adhered thereto, thermal-induced fracture will be induced along a subsurface laser damage region. Spontaneous separation of 4H-SiC at temperatures up to about −20° C. using thermoplastic adhesives disclosed herein, without mechanical intervention, may be achieved.

### Boule-Handling Carrier Shape and Positioning Relative to Crystalline Material

As noted previously, boule-handling carriers may have lateral dimensions (e.g., diameter, or length and width) that are at least as large as, or that exceed, corresponding dimensions of a boule bonded thereto. The boule-handling carriers can have any shape and can include alignment and/or reference features as well as processing equipment retention, handling and/or engagement features. The boule-handling carriers can have various combinations of apertures, channels, grooves, notches and/or carrier body or surface shapes and/or other features that can be used to improve the handling/processing of the boule-boule handling carrier assembly. The alignment/reference features can be used to help align a respective boule for engaging with manufacturing and/or inspection equipment, for assisting in having robotic handling equipment engage with the boule-handling carrier and boule assembly, and/or be used to designate crystal orientation of the boule. These features can comprise alignment features, retention, handling and/or engagement features for processing equipment, for example. FIGS. 14A-14S show non-limiting examples of these features/shapes.

FIGS. 14A-14E are top views of bonded assemblies comprising the boule-handling carrier 164 of different shapes each joined to a boule of crystalline material, with FIGS. 14F and 14G providing side cross-sectional views of the bonded assemblies of FIGS. 14D and 14E, respectively. FIG. 14H is a side cross-sectional view of a bonded assembly similar to FIG. 14D showing an example aperture 1208 in an outer edge portion of the boule-handling carrier 164.

FIG. 14A illustrates a first bonded assembly 110 including a generally circular (boule) substrate 112 having a flat 114 and a rounded portion 116 that opposes the flat 114, with the (boule) substrate 112 being bonded to a square-shaped boule-handling carrier 118 that is substantially concentric with the (boule) substrate 112. The boule-handling carrier 118 can provide the boule-handling carrier 164 discussed herein. The substrate 112 can be the boule 15, 115 or 215 discussed herein.

FIG. 14B illustrates a second bonded assembly 120 including a generally circular (boule) substrate 122 having a flat 124 and a rounded portion 126 that opposes the flat 124, with the (boule) substrate 122 being bonded to a round boule-handling carrier 128 that is substantially concentric with the (boule) substrate 122. Due to presence of the flat 124 that locally reduces diameter of the (boule) substrate 122, a larger border portion 129 of the boule-handling carrier 128 is provided proximate to the flat 124. The boule-handling carrier 128 can also comprise a flat 164F which can be offset from the flat of the boule providing visual indicia that can be used a fiducial for orientation identification for automated handling systems. The boule handling carrier 128 can provide the boule-handling carrier 164 discussed herein. The substrate 122 can be the boule 15, 115 or 215 discussed herein.

FIG. 14C illustrates a third bonded assembly 130 including a generally circular (boule) substrate 132 having a flat 134 and a rounded portion 136 that opposes the flat 134, with the (boule) substrate 132 being bonded to a round boule-handling carrier 138 that is non-concentric with the (boule) substrate 132, such that the rounded portion 136 of the substrate 132 is substantially closer to an edge of the boule-handling carrier 138 than a remainder of the substrate 132. A larger border portion 139 of the carrier 138 can be present opposite the rounded portion 136 even if the flat 134 were absent, but with the flat 134 being present, the border portion 139 of the carrier 138 can be even larger than the border portion 129 shown in FIG. 14B. The boule-handling carrier 138 can comprise one or more fiducial F1 for orientation identification by automated processing systems. The boule-handling carrier 138 can provide the boule-handling carrier 164 discussed herein. The substrate 132 can be the boule 15, 115 or 215 discussed herein.

FIGS. 14D and 14F illustrate a fourth bonded assembly 140 including a generally circular (boule) substrate 142 having a flat 144 and a rounded portion 146 that opposes the flat 144, with the (boule) substrate 142 being bonded to a predominantly round boule-handling carrier 148 that is substantially concentric with the (boule) substrate 142, but with the boule-handling carrier 148 including a single laterally protruding tab portion 149 that provides a locally increased border proximate to the flat 144 of the (boule) substrate 142. The laterally protruding tab portion 149 of the boule-handling carrier 148 may be registered with the flat 144. One or more fiducial F1 can be provided on the tab portion 149. The boule handling carrier 148 can provide the boule-handling carrier 164 discussed herein. The substrate 132 can be the boule 15, 115 or 215 discussed herein.

As shown in FIG. 14F, a boule-handling carrier 148′ of the same or different shape may be provided under the (boule) substrate 142, with the subsurface damage region 143 facing away from the boule-handling carrier 148′. The carrier 148′ can provide the boule-handling carrier 164 discussed herein. The substrate 142 can be the boule 15, 115 or 215 discussed herein.

FIGS. 14E and 14G illustrate a fourth bonded assembly 150 including a generally circular (boule) substrate 152 having a flat 154 and a rounded portion 156 that opposes the flat 154, with the (boule) substrate 152 being bonded to a predominantly round boule-handling carrier 158 that is substantially concentric with the substrate 152, but with the boule handling carrier 158 including opposing first and second laterally protruding tab portions 159A, 159B that provide a locally increased border areas, with one locally increased border area being proximate to the flat 154 of the (boule) substrate 152. The laterally protruding tab portions 159A, 159B of the boule-handling carrier 158 may be registered with the flat 154. One or more fiducials F1 can be provided on one or both tab portions 159A, 159B and one or more aperture 1208 may be provided on one or both tab portions 159A, 159B. The apertures 1208 can be through holes or closed end holes and can be configured to provide handling features for robotic interfaces. The carrier 158′ can provide the boule-handling carrier 164 discussed herein. The (boule) substrate 152 can be the boule 15, 115 or 215 discussed herein.

FIG. 14H illustrates a fifth bonded assembly 155 with a generally circular (boule) substrate 152, a boule-handling carrier 158′ (shown also in FIG. 14G) that can be non-concentric with the (boule) substrate 152. The boule-handling carrier 158′ is the boule-handling carrier 164 discussed above and can be used without a top/wafer-handling carrier so that a top end face of the (boule) substrate 152 is bare and remains bare during processing and separation with the top end face being closer to the subsurface damage 153 than the bottom surface attached to the boule-handling carrier (at least until the end of wafer separations transition to closer to the bottom end face at the boule remnant size). The exposed outer edge portion can comprise an aperture 1208 as discussed above with respect to FIG. 14E.

Turning now to FIGS. 14I-14M, example boule-handling carriers 164 with one or more fiducials, alignment features (e.g., relative to the flat) and/or retention/engagement features to facilitate handling or interfacing with processing equipment such as robotic handlers are shown.

FIG. 14I illustrates a bottom surface 164b of the boule-handling carrier 164 can have one or more apertures 1154 in the form of a closed channel that does not extend through the top surface 164u or in the form of an open through channel that does extend through the top surface 164u. The apertures 1154 can be configured to engage automation equipment such as robotically controlled members for moving the boule-handling carrier to different workstations.

FIG. 14J illustrates fiducials F1, F2 on or in the upper surface 164u of the boule-handling carrier 164 and a laterally extending channel 1254 that may extend entirely or partially through the boule-handling carrier 164 between the top and bottom surfaces 164u, 164b. The laterally extending channel 1254 may be provided as a pair of closed channels that each extend partially through a length and/or width dimension of the boule-handling carrier 164. The laterally extending channel(s) 1254 can be configured to engage automation equipment to move the boule-handling carrier with the boule (the boule/carrier assembly) to different workstations.

FIG. 14K shows the upper surface 164u of the boule-handling carrier 164 with a plurality of spaced apart fiducials F1, F2 and with an aperture 1208 merging into a downwardly extending channel 1254′. The aperture 1208 and channel 1254′ can be configured to provide alignment functions and allow support and retention of the boule in orthogonal or different axes and/or dimensions when being handled or for engaging automation equipment for moving/handling the boule and carrier assembly.

FIG. 14L illustrates that the boule-handling carrier 164 can comprise a plurality of fiducials F1, F2, F3 that have different features and that can be circumferentially spaced apart. FIG. 14L also illustrates surface texture 1156 in the upper surface 164u, such as grooves.

FIG. 14M illustrates that the boule handling carrier 164 can comprise a tracker (also known as a “locator”) 1157 with a wireless communication system, such as a BLUETOOTH communication system, and can comprise a transmitter or transceiver. The locator 1157 can comprise an AIRTAG, GPS tracking device, or other tracking component that can wirelessly communicate with manufacturing systems such as inventory or tracking systems. The locator 1157 can be provided in a recess or pocket 1157p in the boule-handling carrier 164 in any surface thereof, shown on a top surface. The locator 1157 may also be adhesively coupled to a side or top surface of the boule-handling carrier 164 without requiring a pocket or inside the pocket. FIG. 14M also shows that the boule-handling carrier 164 can comprise a computer readable label 1158 such as a barcode, QR code or other computer readable label that can provide information regarding the boule thereon. The information can comprise, for example, an identification number for the boule or some form of binning or characterization information for the boule, such as whether the boule is high purity semi-insulating (HPSI) or other types or characteristics for the boule and/or identification number of the carrier. One or more of the fiducial, location, other informational, alignment, retention and/or handling features can be incorporated with the boule-handling carrier alone or in combination with other features to assist in handling, processing and manufacturing wafers from the boule or other purposes, such as inspection, testing, monitoring, binning and the like.

FIG. 14N shows an alignment feature 1354 with fiducials F1, F2 provided by the boule-handling carrier 164. The boule handling carrier can also comprise one or more engagement, alignment, handling and/or retention features 1254, 1255 (which can comprise grooves, channels, notches, holes). FIG. 14O is a bottom view showing the retention features 1255 can extend laterally, optionally radially where the carrier 164 is cylindrical (FIG. 14O) and can be spaced apart about the perimeter of the boule-handling carrier 164. FIG. 14P shows a that the boule-handling carrier 164 can have a polygon shape with the handling, engagement, alignment and/or retention features 1255. FIG. 14Q shows the boule-handling carrier 164 with the handling, engagement, alignment and/or retention features 1255 engaging robotic handling members 1200. The features 1255 can be provided as open or closed channels, grooves, recesses, holes and the like.

FIG. 14R shows a matrix of grooves or recesses in the bottom 164b of the boule-handling carrier 164 providing the handling, engagement, alignment and/or retention features.

FIG. 14S shows outwardly projecting members 1256 providing alignment, engagement, retention and/or handling interfaces for facilitating automated processing handling interfaces. The outwardly projecting members 1256 can be integral to or bonded to the primary body of the boule-handling carrier 164.

Additional details regarding separation of a wafer which may optionally comprise application of energy and/or force to initiate fracture of a crystalline material along a subsurface damage region are discussed hereinafter.

### Fracturing Induced or Facilitated by Ultrasonic Energy

Another method for effectuating fracture along a laser-induced subsurface damage zone of a crystalline material bonded to a boule-handling carrier involves application of ultrasonic energy to the crystalline material while in the bonded state. FIG. 15A is a cross-sectional schematic view of an assembly 58A including a crystalline material 60A having subsurface damage 66A′ and bonded to a boule-handling carrier 164 with an intervening adhesive material 168, with at least part of assembly 58A arranged in a liquid bath 165 of an ultrasonic generator apparatus 160. The apparatus further includes a vessel 162 arranged in communication with and/or in contact with an ultrasonic generating element 160G, with the vessel 162 containing the liquid bath 165. The entire assembly 58A can be submerged in the liquid bath 165, e.g., under a fill line. One or more handling members 1500 can be releasably coupled to the boule-handling carrier 164 for placing and/or removing the boule-handling carrier 164 and boule 60A, 15, 115, 215, from the vessel 162. However, the boule-handling carrier 164 and boule 60A, 15, 115, 215 can be manually placed and removed and the wafer when separated therefrom can be manually retrieved.

As shown in FIG. 15A, the subsurface damage 66A′ is closer to the top of the vessel 162 with the liquid bath 165 than the boule-handling carrier 164, with the boule-handling carrier closer to the ultrasonic generator element 160G. As is also shown, the boule-handling carrier 164 has the inclined surface 164s.

FIG. 15B shows the boule-handling carrier 164 can be a horizontal carrier without requiring the inclined surface carrier of FIG. 15A. FIG. 15B also shows a single handling member 1500 can be configured to lift the boule-handling carrier 164 with the boule 60A, 15, 115, 215, from the vessel 162. The handling member 1500 can pinch or grip an outer edge portion of the top and bottom surfaces to releasably engage the boule-handling carrier 164.

FIG. 15C shows that the boule-handling carrier 164 can be closer to the top of the vessel 162 with the liquid bath 165 than the boule 115, 215 comprising the subsurface damage 66A with the subsurface damage 66A′ under the liquid fill line. Alternatively, a portion of the assembly 58A including the portion of the crystalline material with the subsurface damage 66A′can be submerged in the liquid bath 165 with another portion including at least a portion of the boule-handling carrier 164 can reside above the liquid bath 165, e.g., above fill line B. As shown with the position associated with fill line B, the carrier 164 may be at least partially above the fill line B. FIG. 15C also illustrates that handling members 1500 can extend into apertures 1154 in the bottom surface 164b of the boule-handling carrier 164 to lift the boule-handling carrier 164 and boule 60A, 15, 115, 215, out of the vessel 162. However, the boule-handling carrier 164 and boule 60A, 15, 115, 215 can be manually placed and removed and the wafer when separated therefrom can be manually retrieved.

Submerging the entire assembly 58A with the entire boule-handling carrier 164 in the liquid bath 165 may facilitate ultrasonic energy transmission through the boule when the boule is under about 10 mm such as between 3-6 mm in height, or even under 3 mm, whereby ultrasonic energy may otherwise be “dampened” by surroundings as the ultrasound energy travels into a chuck directly holding the boule. Stated differently, thin segments of boule held directly by a vacuum chuck or other structure at a location opposing the target thin wafer segment to be separated may not use ultrasonic energy efficiently as the thin boule vibrates ineffectively in response to application of ultrasound energy.

Referring to FIGS. 15D and 15E, without the boule-handling carrier 164 adding mass to the boule remnant 60A as the boule remnant 60A decreases in size, compare the height H₁ in FIG. 15D to H₂ in FIG. 15E, the ultrasound energy tends to move through the boule remnant 60A into the surrounding surfaces and environment which can cause the target slice volume to vibrate at the same frequency as the boule (remnant/bulk) instead of having a different frequency to facilitate separation. Advantageously, the boule-handling carrier 164 can allow ultrasonic separation down to about a last 1 mm to 300 microns or even less of bulk boule forming the boule remnant.

The boule-handling carrier 164 bonded to the boule 215 can add mass to the boule of the remaining crystalline material 60A so that the target slice volume is at a different frequency from the remaining part of the boule adjacent the boule-handling carrier 164. The boule-handling carrier 164 bonded to the boule 60A can allow consistent separation of wafers without requiring manual assistance even as the boule remnant becomes thin, such as under about 10 mm, or in a range of 4-6 mm. As shown in FIG. 15E, during processing, after removal of some wafers, the boule-handling carrier 164 can have a greater height than the boule remnant 60A while wafers are sequentially separated from that boule remnant 60A.

FIG. 15F illustrates that the boule-handling carrier 164 can have an outer perimeter with one or more shaped edge 164e. The term “shaped edge” refers to any shape that is not perpendicular to the bottom 164b or top surface 164u of the boule-handling carrier 164. The shaped edge(s) 164e can comprise one or more fillets, one or more bevels, one or more chamfers or combinations of these shape features or other different shape features between a top and/or bottom surface of the boule-handling carrier 164, shown as adjacent both the top and bottom outer perimeter edges 164e. In certain embodiments, as shown in FIG. 15F, the shaped edge 164e can be provided by a single bevel or chamfer 164c that resides closer to the bottom surface of the boule-handling carrier 164c than the top surface of the boule-handling carrier, such as adjacent a bottom surface thereof to facilitate longevity (avoid chipping upon surface contact at different workstations). The shaped edge 164e can also or alternatively facilitate separation of the boule-handling carrier 164 from the boule 215 at a desired debonding time.

FIG. 15G illustrates that the boule-handling carrier 164 can include an outer perimeter comprising upper and lower shaped edges 164e extending outward from a medial vertical segment.

FIG. 15H illustrates the boule-handling carrier 164 with the inclined surface with the outer perimeter with the shaped edge 164e is positioned below the inclined surface 164s. The shaped edge 164e can have a different shape on the thicker side T1 relative to the thinner side T2 of the carrier 164. The shaped edge 164e can have a different angle providing a bevel or chamfer 164c on the thicker side from the angle providing a bevel or chamfer 164c on the thinner side.

In certain embodiments, liquid of an ultrasonic bath may be cooled either before or during application of ultrasonic energy.

### Fracturing Induced or Facilitated by Mechanical Force

In certain embodiments, fracturing of a crystalline material bonded to a wafer-handling (frontside) carrier may be promoted by application of a mechanical force (e.g., optionally localized at one or more points) proximate to at least one edge of the wafer-handling carrier. Such force may impart a bending moment in at least a portion of the carrier, with such bending moment being transmitted to the subsurface damage region to initiate fracture.

As noted previously herein, multiple fracturing techniques may be used simultaneously or sequentially. Certain embodiments may utilize CTE mismatch in combination with mechanical force. If a significant CTE mismatch between a (boule) substrate and wafer-handling carrier is present and temperature is appropriately lowered, then less (or zero) mechanical force may be required to promote separation. Conversely, if a low (or zero) degree of CTE mismatch is present between a (boule) substrate and wafer-handling carrier, then more mechanical force may be required to complete separation.

Exemplary embodiments promoting fracture of crystalline material having subsurface damage and bonded to wafer-handling and boule-handling carriers by application of a mechanical force are shown in FIGS. 16A-16D and 17A-17B.

FIGS. 16A-16D are cross-sectional schematic views illustrating steps for fracturing a crystalline material substrate 145 having subsurface damage 143 by application of a mechanical force proximate to one edge of a wafer-handling carrier 148 to which the substrate 145 is bonded. The wafer-handling carrier 148 and the boule-handling carrier 164 can include a laterally protruding tab portion 149, 149′ registered with a flat 145 of the (boule) substrate 145, providing a local increased border region that defines a recess 141 into which a tool 166 may be inserted.

FIG. 16A illustrates a state prior to insertion of the tool 166 into the recess 141. FIG. 16B illustrates a state following insertion of the tool 166 into the recess, when the tool 166 is tilted upward, thereby exerting a prying force in a direction tending to promote separation between the wafer-handling carrier 148 and the boule-handling carrier 164, thereby exerting a bending moment M on the wafer-handling carrier 148.

In certain embodiments, the boule 15, 115, 215 providing substrate 145 comprises a material (e.g., 4H—SiC) having hexagonal crystal structure and the bending moment M is oriented within ±5 degrees of perpendicular to a <1120> direction (or, equivalently, within ±5 degrees of parallel to a <1100> direction) of the hexagonal crystal structure. Such orientation of the bending moment M is particularly desirable if the substrate 142 comprises off-axis (vicinal) material; this orientation may be less critical if the substrate 142 comprises on-axis material. FIG. 16C illustrates a state following initial fracture of the crystalline material substrate 142 along the subsurface damage region 143, whereby an upper portion 146A of the crystalline material remains bonded to the wafer-handling carrier 148, and a lower portion 146B of the crystalline material remains bonded to the boule-handling carrier 164, and the wafer-handling carrier 148 is tilted upward relative to the boule-handling carrier 164. FIG. 16D illustrates a state after fracture is complete and the tool 166 is removed, yielding a first bonded assembly 168A (including the wafer-handling carrier 148 and the upper portion 146A of the crystalline material) separated from a second bonded assembly 168B (including the boule-handling carrier 164 and the lower portion 146B of the crystalline material).

In certain embodiments, mechanical force may be applied proximate to opposing edges of a wafer-handling carrier, which can be rigid, to which a boule is bonded to promote fracture of a crystalline material having subsurface damage that is bonded to the wafer-handling carrier. FIG. 17A is a cross-sectional schematic view of an apparatus 170 for fracturing a boule of crystalline material 172 along a subsurface damage region 173 by applying mechanical force along opposing edges of a carrier 176 (bonded to the boule 172 with adhesive material 174) to impart bending moments M₁, M₂ in portions of the carrier 174. A restraining element 171, e.g., a vacuum chuck or other workstation support, holding the boule-handling carrier 164 (which can be configured to provide the horizontal support surface or the inclined surface discussed above, FIGS. 6, 7A, 7B) which is coupled to the boule 172 may be provided below the boule substrate 172. The boule substrate can be the boule 215 discussed above. A lateral extent (e.g., diameter, or length and width) of the carrier 176 is greater than the substrate 172, with the carrier 176 forming opposing laterally protruding lips 179A, 179B that may be received by lifting members 175A, 175B. The opposing lips 179A, 179B may be a single lip extending about an outer perimeter of the wafer-handling carrier 176. A central portion of the wafer-handling carrier 176 is restrained from being lifted (e.g., depressed downward) by a restraining member 177. When a vertical lifting force is applied to the laterally protruding lips 179A, 179B by the lifting members 175A, 175B, and the central portion of the wafer-handling carrier 176 is prevented from moving upward by the restraining member 177, opposing bending moments M₁, M₂ are exerted on the wafer-handling carrier 176, and such bending moments M₁, M₂ are transmitted to the substrate (boule) 172 by the adhesive material 174 to initiate fracture of the substrate 172 along the subsurface damage region 173. Thereafter, the restraining member 177 and lifting members 175A, 175B may be released, and fracture may be completed. FIG. 17B shows a state in which fracture is complete, producing a bonded assembly 178 including the wafer-handling carrier 176, adhesive material 174, and a crystalline material substrate portion 172A separated from a remainder of the crystalline material 172. Exposed surfaces 173A, 173B of the crystalline material substrate portion 172A and the remainder of the crystalline material 172 may remain bonded to the boule-handling carrier 164 with an exposed surface that exhibits surface irregularities that may be reduced by conventional surface processing steps (e.g., grinding, CMP, and/or polishing). In certain embodiments, such surface processing steps may be performed on the crystalline material substrate portion 172A while such portion remains bonded to the wafer-handling carrier 176.

Although FIGS. 16A-16D and 17A-17B provide examples of specific apparatuses to promote mechanical fracturing of substrates along subsurface damage regions, it is to be appreciated that other apparatuses may be used to practice methods disclosed herein, as will be recognized by one of ordinary skill in the art.

### Subsurface Damage Formation Before or After Boule-Carrier Bonding

Different substrate subsurface damage formation configurations are shown in FIGS. 18A-18B for a boule of crystalline material 182 which may be the boule 15, 115 or 215 discussed above while bonded to a respective boule-handling carrier. FIG. 18A is a schematic view of laser emissions 181 being focused through a surface of a bare boule (substrate) 182 to form subsurface laser damage 183 within the boule 182 while coupled to the boule-handling carrier 164 below the laser damage. No wafer-handling second carrier is required but where used such a wafer-handling carrier may be affixed to the substrate 182 following formation of the subsurface laser damage. The boule-handling carrier 164 can be an inclined carrier such as shown in FIG. 7A and can be affixed via adhesive or anodic bonding or other adhesiveless means. FIG. 18B is a schematic view of laser emissions 181 being focused through a bare surface of a boule 182 to form subsurface laser damage 183 within the substrate 182, with the substrate 182 having previously been bonded to a horizontal support surface of a boule-handling carrier 164 such as shown in FIGS. 6 and 7B.

### Device Wafer Separation Process

In certain embodiments, a laser- and carrier-assisted separation method using one or more of the boule-handling and/or wafer-handling carriers discussed herein may be applied to a crystalline material after formation of at least one epitaxial layer thereon (and optionally at least one metal layer) as part of an operative semiconductor-based device. Such a device wafer splitting process may be particularly advantageous for the ability to increase yield (and reduce waste) of crystalline material by significantly reducing the need for grinding away substrate material following device formation.

A thick wafer can be fractured from a crystalline material, at least one epitaxial layer is grown on the thick wafer, and the thick wafer is fractured to form a first and second bonded assemblies each including a boule-handling carrier or a wafer-handling carrier and a thin wafer divided from the thick wafer, with the first bonded assembly including the at least one epitaxial layer as part of an operative semiconductor-based device. In certain embodiments, the thick wafer may have a thickness in a range of above 300 micrometers to about 1500 microns/micrometers. Thin or “regular” wafers can have a thickness in a range of 150 to about 300 microns. Exposed surfaces of the thick wafer and the remainder of the substrate respectively may exhibit surface irregularities that may be reduced by surface processing steps such as grinding, CMP, polishing, etc.

### Exemplary Method Including Re-Use of Carrier(s)

FIGS. 19A and 19B are flowcharts that schematically illustrate steps of a method of processing crystalline material according to the present disclosure. FIG. 19A shows the use of a boule-handling carrier 164 with a horizontal upper surface 164u and FIG. 19B shows the use of a boule-handling carrier 164 with an inclined upper surface 164u. Starting at upper left, a laser 216 at a laser workstation 216w may focus laser emissions below a first surface 222 of a boule forming a thick crystalline material substrate 220 (e.g., a SiC ingot) while the boule of crystalline material substrate 220 is coupled to a boule-handling carrier 164 at an opposing second surface 223 to produce a subsurface damage region 218. The processing can include bonding the boule-handling carrier to the boule prior to presenting the boule 222 and boule-handling carrier 164 to the laser workstation 216w. The boule-handling carrier 164 can be an inclined support surface carrier (FIG. 19B) or a horizontal support surface carrier (FIG. 19A) that can be bonded directly to the second surface 223 without an adhesive or that can be bonded to the second surface 223 with an adhesive 168 that may be an ultraviolet curable epoxy adhesive. If the crystalline material substrate 220 is SiC material, then the laser emissions may be impinged through a C-terminated face of the SiC substrate 220. Thereafter, the boule and boule-handling carrier are presented to a separation workstation 161w for a fracturing process as disclosed herein (e.g., cooling a CTE mismatched carrier, application of ultrasonic energy, and/or application of mechanical force) is applied to a bare end face or an end face devoid of a wafer-handling carrier to fracture the crystalline material 220 along the subsurface damage region 218, causing a wafer of crystalline material 230 to be separated from a remainder of the boule of crystalline material substrate 220A.

A newly exposed surface 232A of the remainder of the crystalline material substrate 220A having residual laser damage is ground smooth at one or more grinding and polishing workstations 163w and evaluated at one or more metrology workstations 1163w and cleaned at one or more cleaning workstations 1165w then returned to the laser workstation 216w at the beginning of the process (at upper left in FIGS. 19A, 19B). The cleaning can be carried out before or after the metrology or both before and after the metrology. Also, a newly exposed surface 234 of the removed crystalline material 230 is polished and/or ground smooth at a grind and/or polishing workstation(s) 1169w. The wafer of crystalline material 230 may be subject to epitaxial growth of one or more layers to form an epitaxial device 230′.

FIG. 19C is a flowchart schematically illustrating steps of a method of processing crystalline material according to the present disclosure. Starting at upper left, subsurface damage is formed, by any suitable wafer-forming technology, including ion implantation and not requiring lasers, below a first surface 222 of a boule 220 (e.g., SiC ingot or thick SiC crystalline material) forming a thick crystalline material substrate (e.g., a SiC ingot) while the boule 220 is coupled to a boule-handling carrier 164 at an opposing second surface 223 to produce a subsurface damage region 218. The boule-handling carrier 164 can be an inclined support surface carrier or a horizontal support surface carrier that can be bonded directly to the second surface 223 without an adhesive or that can be bonded to the second surface 223 with an adhesive 168 that may be an ultraviolet curable epoxy adhesive. If the crystalline material substrate 220 is SiC material, then the damage can be formed about a C-terminated face of the SiC substrate 220. Thereafter, a wafer-handling carrier 224 can optionally be attached to the first surface 222 of the boule of crystalline material 220, with the optional wafer-handling carrier 224 including a first surface 226 (proximal to the first surface 222 of the boule 220) and a second surface 228 that opposes the first surface 226 of the second carrier 224. Such coupling or attachment between the boule-handling carrier 164 and the boule 220 and the optional wafer-handling carrier 224 and the boule 220 may be performed by any method such as any of those disclosed herein, such as by bonding comprising adhesive bonding or anodic bonding. The boule-handling carrier 164 can be bonded to the boule 220 using a different adhesive and bonding process than the optional wafer-handling carrier 224 to bond to the boule 220. Thereafter, a separation process such as sawing or other action, e.g., cooling a CTE mismatched carrier, application of ultrasonic energy, and/or application of mechanical force, is applied to fracture the boule of crystalline material 220 about the subsurface damage region 218, causing a crystalline material portion 230 optionally bound to the wafer-handling carrier 224 to be separated from a remainder of the boule of crystalline material 220A. The boule 220 can be boule 15, 115, 215, discussed above.

As with FIGS. 19A and 19B, a newly exposed surface 232A of the remainder of the crystalline material 220A having residual laser damage is ground smooth and cleaned and returned to the beginning of the process (at upper left in FIG. 19C). Also, a newly exposed surface 234 of the removed crystalline material 230 is ground smooth while attached to the wafer-handling carrier 224. The wafer-handling carrier 224 may be separated from the wafer/removed portion of the crystalline material 230 at any stage, typically after a coarse grind, where such wafer-handling carrier 224 is used. The crystalline material 230 may be subject to epitaxial growth of one or more layers to form an epitaxial device 230′, while the wafer-handling carrier 224 is cleaned and optionally returned to a beginning portion of the process (at upper part in FIG. 19C) to be reused with the boule being processed or another boule to effectuate removal of another relatively thin section (wafer) of the boule of crystalline material 220.

One or both of the boule-handling carrier and the wafer-handling carrier, where used, can be reused or can be single-use.

FIG. 20 is a cross-sectional schematic view of a portion of the boule of crystalline material (e.g., SiC ingot) 220 of FIGS. 19A-19C showing subsurface damage 218 with superimposed dashed lines identifying an anticipated kerf loss material region 240. The anticipated kerf loss material region 240 includes damage 218, plus material 234 to be mechanically removed (e.g., by grinding and polishing) from a lower face 238 (e.g., Si-terminated face) of the crystalline material portion 230 (e.g., SiC wafer) to be separated from the boule 220, plus material 236 to be mechanically removed (e.g., by grinding and polishing) from an upper face 232A (e.g., C-terminated) face of the remainder 220A of the boule 220. The lower face 238 of the crystalline material portion 230 opposes an upper face 222 thereof. In certain embodiments, the entire kerf loss material region may have a thickness in a range of from 80-120 microns for SiC to provide a substrate upper face 232A and a wafer lower face 238 sufficient for further processing.

Material Processing with Multiple Grinding Stations/Steps

In certain embodiments, respective boules of crystalline material subjected to processing and separation may be further processed with multiple surface grinding steps to remove subsurface damage and edge grinding to impart a beveled or rounded edge profile, wherein an order of grinding steps can be selected and/or a protective surface coating can be employed to reduce the likelihood of imparting additional surface damage and to render a crystalline material wafer ready for chemical and/or mechanical planarization. Such steps may be performed, for example, using material processing apparatuses according to embodiments disclosed herein, wherein an exemplary apparatus includes a laser processing station, a fracturing station, one or multiple coarse grinding stations arranged in series or parallel downstream of the separation station, and at least one fine grinding or polishing station arranged downstream of the coarse grinding stations. When processing wafers cut by wire sawing, it is commonplace to perform edge grinding prior to surface grinding or polishing to remove wire-sawing surface damage. However, it has been found that edge grinding of substrate portions (e.g., wafers) having laser damage in combination with fracture damage, the likelihood of cracking a substrate portion is increased. While not wishing to be bound by any specific theory as to the reason for this phenomenon, it is believed that exposed cleave planes resulting from surface fracturing renders the surfaces susceptible to cracking if edge grinding is performed prior to at least some surface processing (grinding and/or polishing). For this reason, it has been found to be beneficial to perform at least some surface processing (e.g., grinding and/or polishing) prior to edge grinding, where used.

Coarse grinding steps (i.e., to remove damage and separation/fracture damage along surfaces of a substrate portion and a bulk substrate) may require significantly longer time to complete than the preceding steps of laser processing and fracturing, and significantly longer than subsequent steps of fine grinding. For that reason, multiple coarse grinding stations can be provided in parallel to remove a bottleneck in fabrication of multiple wafers from a bulk crystalline material (e.g., an ingot). In certain embodiments, robotic handlers may be arranged upstream and downstream of the multiple coarse grinding stations to control loading and unloading of substrate portions. In certain embodiments, a first carrier (boule-handling carrier) bonding station can be provided before the laser processing station and a second carrier (wafer-handling) bonding station—where used (FIG. 19C) as such is not required according to certain embodiments as discussed above with respect to FIGS. 19A and 19B, for example—may be provided between a damage inducing station, e.g., a laser processing station, and a separation station, e.g., a fracturing station, and a carrier removal station may be provided upstream (either directly or indirectly) of an edge grinding station. Where used, a respective wafer-handling carrier may remain bonded to a substrate portion during at least some surface grinding steps to reduce the potential for breakage, particularly for thin substrate portions (e.g., wafers); however, the wafer-handling carrier, where used, can be removed prior to edge grinding (or prior to coating wafer with a protective coating preceding edge grinding).

In certain embodiments, one or both carrier bonding stations may use carriers pre-coated with temporary bonding media, align and press the carrier to a substrate surface, and subject the bonding media with the necessary conditions (e.g., heat and pressure) to effectuate bonding between the carrier and the substrate. Alternatively, a carrier bonding station may include a coating station that may be used to coat the boule-handling carrier and/or the wafer-handling carrier or a boule end faces on demand.

FIG. 21 is a schematic illustration of an example material processing system or apparatus 300, which may be provided as one system/apparatus or a plurality of cooperating systems or apparatus, according to embodiments of the present disclosure, comprising a (boule-handling) carrier bonding station 301, where a boule-handling carrier is bonded to the boule, a laser processing station 302, where a wafer separation layer is formed, a material fracturing station 304, where the wafer is separated from the boule about the wafer separation layer. In this example embodiment, the separated wafer is provided manually or with automation equipment to at least one grinding station 308A for the separated wafer, and one or more further processing stations for the separated wafer 309 (CMP, epitaxy growth, cleaning, for example).

The boule assembly comprising the boule and boule-handling carrier is provided manually or by automation equipment from the carrier bonding station 301 to the laser processing station 302. The exposed boule surface opposite the boule-handling carrier can be initially ground or processed at an initial grind/processing station 299 prior to or after bonding the boule handling carrier to the boule. In this embodiment, after the boule is mounted to the boule-handling carrier, the top (exposed) surface of the boule is prepared at the initial grind/processing station 299 for laser processing. The boule assembly is provided to the laser processing station (manually or by automated equipment). The laser processing station 302 can include at least one laser, and a holder configured to receive at least one boule carrier assembly for formation of subsurface laser damage in the crystalline material (e.g., boule or ingot). The fracturing station 304 is arranged to receive (manually or with automation equipment) one or more assemblies with the subsurface laser damage region to fracture the boule about the subsurface laser damage region to remove a respective substrate portion or a wafer. The boule assembly with the newly exposed surface where the wafer was removed is provided (manually or with automation equipment) to a grinding station 308B. The boule assembly can be delivered to the grinding station 308B to grind the newly exposed surface of the boule. In certain embodiments, the boule assembly can then be delivered (manually or with automation equipment) to a fine grinding and/or polishing station 312, cleaning station 321, metrology station 329, or other processing station(s) to prepare the top surface of the boule for the next laser processing step or as a prepared surface of the last wafer from the boule if at an end of boule. The cleaning station 321 can be after the metrology station 329 or before and after the metrology station 329. A determination 330 is made as to whether the boule is at the end. If the boule is at the end (a boule remnant), a boule-handling carrier removal station 313 is provided and serves to separate any remaining boule remnant or wafer from the boule-handling carrier at an “end-of-boule” processing step(s). The boule-handling carrier can be presented manually or by automation equipment to a boule-handling further processing station 314, which can comprise a cleaning station, and reused for other boules. In certain embodiments, each coarse grinding station 308A, 308B comprises at least one grinding wheel having a grinding surface of less than 5000 grit, and the fine grinding/polishing station 312 can comprise at least one grinding wheel having a grinding surface of at least 5000 grit. In certain embodiments, one or both coarse grinding stations 308A, 308B can be configured to remove a thickness of 20 microns to 100 microns of crystalline material from a crystalline material portion (e.g., wafer or boule body), and the fine grinding/polishing station 312 can be configured to remove a thickness of 3 to 15 microns of crystalline material. In certain embodiments, each coarse grinding station 308A, 308B and/or fine grinding station 312 may include multiple grinding substations, in which different substations comprise grinding wheels of different grits. The laser, fracturing and grinding processes can be repeated until the boule 220 is depleted to a small remnant, while attached to the boule-handling carrier. The determination 330 can be carried out so that when a small remaining boule amount or boule remnant remains it can be identified as at an end state (end of boule? Y, N decision), such as when the boule remnant is at a height of under 1 mm, such as about 300 microns or less, the bonded assembly of boule remnant and carrier can be provided to the carrier removal station 313 to separate the carrier from the remnant or a remaining wafer. Then, the boule-handling carrier can be provided to the further processing (e.g., cleaning) station 314 and processed to be re-usable for another boule. The boule-handling carrier can alternatively be single or multi-use disposable.

FIG. 22 is a schematic illustration of another example material processing system or apparatus 300, which may be provided as one system/apparatus or a plurality of cooperating systems or apparatus, according to embodiments of the present disclosure, including a first (boule-handling) carrier bonding station 301B, which bonds the boule-handling carrier to the boule. The boule alone or bonded to the boule handling carrier can be presented (manually or by automated equipment) to a grinding workstation 299 for initial processing of the top of the boule to prepare the top of the boule for laser processing. The boule can be provided (manually or by automated equipment) to the grinding workstation 299 after the boule-handling carrier is bonded to the boule or before the boule-handling carrier is boned to the boule. The boule-handling carrier can bond an inclined or horizontal boule-handling carrier 164 to the (bottom end of) boule.

The boule assembly (boule bonded to the boule-handling carrier) can then be provided (manually or by automated equipment) to a laser processing station 302 for generating the subsurface laser damage. The boule assembly can be provided (manually or by automated equipment to a second (wafer-handling) carrier bonding station 303, where the wafer-handling carrier is bonded to the top of boule. The boule assembly with the wafer-handling carrier is provided (manually or by automated equipment) to a material fracturing station 304 to separate a wafer attached to the wafer-handling carrier.

The fracturing station 304 is arranged to receive (manually or with automation equipment) one or more assemblies with the subsurface laser damage region to fracture the boule about the subsurface laser damage region to remove a substrate portion or a wafer. The wafer assembly can be provided to a coarse grinding station 1308A similar to the coarse grinding station 308A discussed above for FIG. 21. The boule assembly with the newly exposed surface where the wafer is removed is provided (manually or with automation equipment) to a boule assembly processing station(s) 1308B, for further processing. The boule assembly processing station(s) 1308B can comprise a coarse grinding station to grind the newly exposed surface of the boule assembly. In certain embodiments, the boule assembly can be delivered (manually or with automation equipment) one or more other boule-assembly processing stations providing the boule-assembly processing station(s) 1308B, which as shown in FIG. 21, can comprise the coarse grinding station 308B, the fine grinding/polishing station 312, the cleaning station 321, metrology station 329 and/or or other processing station(s) to prepare the top surface of the boule for the next laser processing step or as a prepared surface of the last wafer from the boule if at an end of boule. If not, the boule assembly with the boule-handling carrier can again be provided (manually or by automated equipment) to the laser processing 302.

A determination is made as to whether the boule is at the end. If the boule is at the end (a boule remnant), the boule assembly can be provided (manually or by automated equipment) to a boule-handling carrier removal station 313 (FIG. 21) to separate any remaining boule remnant or wafer from the boule-handling carrier at an “end-of-boule” processing step(s). The boule-handling carrier can then be provided (manually or by automated equipment) to a cleaning station and reused for other boules. The boule handling carrier can alternatively be single use disposable or multiple-use disposable. The laser, fracturing and grinding processes can be repeated until the boule 220 is depleted to a small remnant, while attached to the boule-handling carrier. The determination can be carried out so that when a small remaining boule amount or boule remnant remains it can be identified as at an end state (end of boule? Y, N decision), such as when the boule remnant is at a height of under 1 mm, such as about 300 microns or less, the bonded assembly of boule remnant and carrier can be provided to the carrier removal station 313 (FIG. 21), then the boule-handling carrier, alone, can be provided to the further processing (e.g., cleaning) station 314 and processed to be re-usable for another boule.

The coarse grinding station 1308A and/or the boule handling and boule assembly further processing station(s) 1308B can comprise multiple coarse grinding stations. The apparatus/system can also include a fine grinding station for the wafer, a wafer-carrier removal station, and a CMP station 1314.

In certain embodiments, the first carrier bonding station 301B can be used twice so as to also define the second carrier bonding station to perform the bonding of both the boule-handling and wafer-handling carriers using the same or different adhesives with the wafer-handling (second) carrier bonded to the boule after the laser processing station. Alternatively, the second bonding station 303 can be a separate dedicated second carrier bonding station positioned downstream of the laser processing station 302 and the first carrier bonding station 301B.

As discussed with respect to FIG. 21, the laser processing station 302 includes at least one laser, and a holder for at least one boule of crystalline material arranged to receive at least one laser beam for formation of subsurface laser damage in the crystalline material (e.g., boule or ingot). The second carrier bonding station 303 is configured to bond the crystalline material (having subsurface laser damage therein) to at least one wafer-handling carrier. The fracturing station 304 is arranged to receive one or more assemblies (each including a boule bonded to two carriers) from the second carrier bonding station 303, and to fracture the at least one boule or ingot about a subsurface laser damage region to remove a substrate portion (which may resemble a wafer bonded to a respective carrier). This carrier removal station 313 can be used to remove the boule-handling carrier after the boule and boule-handling carrier assembly has been processed through a plurality of laser and fracture actions to remove a plurality of respective wafers down to a remnant amount of the boule. The wafer-handling carrier and the boule-handling carrier can be cleaned and reused for other boules or be single-use disposable. A chemical mechanical planarization (CMP) station 1314 can be arranged downstream of the carrier removal station to prepare substrate portions for further processing, such as cleaning and epitaxial growth. The CMP station 1314 functions to remove damage remaining after fine grinding, which itself removes damage remaining after coarse grinding.

An apparatus according to that of FIG. 21 may be modified to accommodate edge grinding to impart a rounded or beveled edge profile of a crystalline substrate portion, such as a wafer. Such an edge profile will reduce the risk of breakage of a wafer edge. The edge grinding may not be performed when a substrate portion is bonded to a carrier; accordingly, a carrier removal station may be arranged upstream (either directly or indirectly) of an edge grinding station.

The apparatus/system of FIG. 21 can be configured without the wafer-handling carrier and second carrier bonding workstation. Also, the apparatus/system can incorporate an edge grinding station.

An exemplary edge grinding station may be arranged to grip a wafer between upper and lower gripping portions of a turntable arranged proximate to a rotary grinding tool having a concave surface. Gripping of a wafer in this manner may undesirably impart damage to a wafer surface (e.g., a Si-terminated surface of a SiC wafer). For this reason, the edge grinding station for a wafer can be arranged upstream of the fine grinding station 312, to permit any surface damage imparted by the edge grinding station to be removed in the fine grinding station. Although the fine grinding station 312 may remove a small degree of thickness of a wafer, thereby altering a rounded or beveled edge profile produced by the edge grinding station, a sufficient degree of a rounded or beveled edge profile will remain to inhibit fracture of a wafer edge.

The system or apparatus may be used to perform a method for processing a crystalline material wafer comprising a first surface having surface damage thereon, with the first surface being bounded by an edge. The method comprises grinding the first surface with at least one first grinding apparatus to remove a first part of the surface damage; following the grinding of the first surface with the at least one first grinding apparatus, edge grinding the edge to form a beveled or rounded edge profile; and following the edge grinding, grinding the first surface with at least one second grinding apparatus to remove a second part of the surface damage sufficient to render the first surface suitable for further processing by chemical mechanical planarization. In certain embodiments, the first grinding apparatus may be embodied in the (coarse) grinding stations, the edge grinding may be performed by the edge grinding station, and the second grinding apparatus may be embodied in the fine grinding station.

In certain embodiments, a protective surface coating may be employed to reduce the likelihood of imparting additional surface damage during edge grinding and to render a crystalline material wafer ready for chemical mechanical planarization. Such a surface coating may include photoresist or any other suitable coating material, may be applied prior to edge grinding, and may be removed after edge grinding.

The apparatus/systems described herein (see, FIG. 22) can incorporating a surface coating station between a fine grinding station 312 and an edge grinding station and incorporating a coating removal station between the edge grinding station and a CMP station 1314. The coating station may be configured to apply a protective coating (e.g., photoresist) by a method such as spin coating, dip coating, spray coating, or the like. The protective coating should be of sufficient thickness and robustness to absorb any damage that may be imparted by the edge grinding station. For a SiC wafer, the Si-terminated surface may be coated with the protective coating, since the Si-terminated surface is typically the surface on which epitaxial growth is performed. The coating removal station may be configured to strip the coating by chemical, thermal, and/or mechanical means.

The apparatus/systems described herein may be used to perform a method for processing a crystalline material wafer comprising a first surface having surface damage thereon, with the first surface being bounded by an edge. The method comprises grinding the first surface with at least one first grinding apparatus (e.g., the coarse grinding station 1308A (FIG. 22)) to remove a first part of the surface damage; thereafter grinding the first surface with at least one second grinding apparatus (e.g., the fine grinding station 312 (FIG. 22)) to remove a second part of the surface damage sufficient to render the first surface suitable for further processing by chemical mechanical planarization; thereafter forming a protective coating on the first surface (e.g., using the surface coating station); thereafter edge grinding the edge to form a beveled or rounded edge profile (e.g., using the edge grinding station); and thereafter removing the protective coating from the first surface (e.g., using the coating removal station). The first surface may thereafter be processed by chemical mechanical planarization (e.g., by the CMP station 1314 (FIG. 22)), thereby rendering the first surface (e.g., a Si terminated surface of the wafer) ready for subsequent processing, such as surface cleaning and epitaxial growth.

In certain embodiments, a gripping apparatus may be configured for holding an ingot having end faces that are non-perpendicular to a sidewall thereof to permit an end face to be processed with a laser for formation of subsurface damage. In certain embodiments, gripping effectors may conform to a sloped sidewall having a round cross-section when viewed from above. In certain embodiments, gripping effectors may include joints to permit gripping effectors to conform to the sloped sidewall.

FIG. 23A is a schematic side cross-sectional view of a first gripping apparatus 362 for holding an ingot 364 having end faces 366, 368 that are non-perpendicular to a sidewall 370 thereof, according to one embodiment. A robotic handler 1200′ engages the ingot 364 and/or carrier 372. The upper end face 366 is horizontally arranged to receive a laser beam 376. The lower end face 368 may have a carrier 372 attached thereto, with a chuck 374 (e.g., a vacuum chuck) retaining the carrier 372. The ingot 364 can be the boule 215 (FIG. 5) discussed above and the carrier 372 can be the boule-handling carrier 164 discussed above. Gripping effectors 378 having non-vertical faces are provided to grip sidewalls 370 of the ingot 364, wherein the gripping effectors 378 are arranged at non-perpendicular angles A1, A2 relative to horizontal actuating rods 380. Holding the ingot 364 as shown (e.g., proximate to a bottom portion thereof) using the gripping apparatus 362 leaves the upper end face 366 and upper portions of the sidewall 370 available for processing using methods disclosed herein. The carrier 372 can be the inclined or horizontal boule-handling carrier 164 discussed above. The carrier 372 can comprise the alignment and/or engagement features such as 1254, 1255 discussed above and can engage a robotic handler comprising robotic equipment 1200′.

FIG. 23B is a schematic side cross-sectional view of a second gripping apparatus 362′ for holding an ingot 364′ having end faces 366′, 368′ that are non-perpendicular to a sidewall 370′ thereof, according to one embodiment. The upper end face 366′ is horizontally arranged to receive a laser beam 376, whereas the lower end face 368′ may have a carrier 372′ attached thereto, with the carrier 372′ retained by a chuck 374′. The ingot 364′ can be the boule 215 (FIG. 5) discussed above and the carrier 372′ can be the boule-handling carrier 164 discussed above. Gripping effectors 378′ having non-vertical faces are provided to grip sidewalls 370′ of the ingot 364′, wherein the gripping effectors 378′ are arranged at non-perpendicular angles A1, A2 relative to horizontal actuating rods 380′. Pivotable joints 382′ are provided between the actuating rods 380′ and the gripping effectors 378′, thereby facilitating automatic alignment between the gripping effectors 378′ and sidewalls 370′ of the ingot 364′. The carrier 372′ can be the boule-handling carrier 164 and can comprise the alignment and/or engagement features discussed in FIGS. 14A-14S above, such as 1254, 1255 discussed above and can engage robotic equipment 1200′.

The following examples disclose further non-limiting embodiments of the disclosure.

### Example 1

A boule which may be a boule having a 50 mm-400 mm outer diameter single crystal SiC boule (ingot) and having a height/thickness of more 0.5 mm or more, such as in a range of 0.5 mm to about 10 mm or more (such as 11 mm to 10 cm) can be provided as a starting material for production of SiC wafers having a thickness in a range of about 150 um to 1500 um in wafer thickness. A UV light transmissible or optically transmissive or transparent carrier such as quartz or a floated borosilicate glass boule-handling carrier is bonded to the boule using a UV curable two-part epoxy adhesive comprising resin and a hardener with a bond strength in the range of about 2500 psi to 8500 psi. The boule with the subsurface damage, bonded to the boule-handling carrier, are provided to a facture station comprising an ultrasound system that delivers ultrasound energy to the boule with the end face of the boule with the subsurface damage bare, exposed to environmental conditions, devoid of any carrier thereon, to induce fracture about the subsurface damage region is performed to separate a wafer portion of SiC from a remainder of the ingot about the subsurface damage region. Both the separated wafer portion and a newly exposed surface/end face of the remainder of the boule still attached to the UV light transmissive or transparent boule-handling carrier, are separately coarse ground such as by using a 2000 grit grind wheel (e.g., a metal, vitreous, or resin bond-type grinding wheel) to remove visible laser and fracture damage. Thereafter, both the wafer portion and the newly exposed end face of the ingot remainder can be fine ground (e.g., using a vitreous grinding surface) with a 7000 or higher grit (e.g., up to 30,000 grit or higher) to yield smoother surfaces, preferably less than 4 nm average roughness (Rₐ), more preferably in a range of 0.2-2 nm Rₐ. On the boule remainder, a smooth surface avoids any impact on the subsequent laser processing. The wafer is to be CMP ready and of sufficient smoothness to minimize required CMP removal amounts, since CMP is typically a higher cost process. Typical material removal during fine grind processing may be in a thickness range of 5 to 10 microns to remove all residual subsurface damage from the coarse grind and any remaining laser damage (both visible and non-visible to the naked eye).

The bonded boule-handling carrier and boule can be provided to an ion implantation or laser workstation for providing subsurface damage. If the latter, laser emissions are impinged through a bare end face of the SiC substrate to form subsurface laser damage prior to each sequential fracturing event. However, ion implantation may be used for providing the subsurface damage.

Thereafter, the boule remainder, still attached to the UV light transmissible or transparent boule-handling carrier, is returned to the laser workstation (where laser induced damage is used), then to the fracture station for repeating the laser processing, then the separating processing, then the grinding processing to separate at least 10 different wafers.

The boule remains remain bonded to the UV light transmissible or transparent boule-handling carrier even after exposure to forces from high-energy ultrasound fracturing energy and repeated torsional grinding forces associated with 10-100 or even more wafer separations allowing for separations of wafers down to the last about 300 microns (about 300 μm) at the bottom/remnant of the ingot/boule thereby improving product yield to 81%-88% from respective boules without requiring manual separations. The ability to provide a sufficient bond for a boule-handling carrier that provides the structural strength and durability/longevity of an entire boule during many separations and many grinding operations meets a long-felt need, reduces manufacturing costs and, where an inclined boule-handling carrier is used with off-axis crystalline material, can also eliminate the requirement for EDM processing (FIG. 7A) to prepare a boule for wafer separations.

The boule-handling carrier can have an inclined surface or can have a horizontal surface attachable to the boule.

Any of the various features and elements as disclosed herein may be combined with one or more other disclosed features and elements unless indicated to the contrary herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims.

In the claims, means-plus-function clause are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of processing crystalline material, the method comprising:
providing a boule comprising the crystalline material, the boule having a top end and an opposed bottom end;
providing a boule-handling carrier that has a first surface extending in a first plane and an opposing second surface extending in a second plane, wherein the second surface is not parallel to the first surface;
bonding the second surface of the boule-handling carrier to the bottom end of the boule; and then
performing at least one processing step on the top end of the boule.

2. The method of claim 1, wherein the performing comprises grinding the top end of the boule so that the top end of the boule has a planar surface that is parallel to the first surface of the boule-handling carrier.

3. The method of claim 1, wherein the second surface of the boule-handling carrier has an angle of inclination from horizontal that corresponds to an angle of a crystal plane of the boule.

4. The method of claim 1, wherein the performing comprises separating wafers from the top end of the boule.

5. The method of claim 1, wherein the second surface of the boule-handling carrier extends at an angle of inclination with respect to the first plane that increases from one side to an opposing side thereof, and wherein the angle of inclination with respect to the first plane is greater than zero degrees and less than about 15 degrees.

6. The method of claim 2, wherein the top end of the boule comprises a curvilinear surface prior to the grinding.

7. The method of claim 1, wherein the performing comprises separating a wafer from the top end of the boule then grinding and/or polishing a newly exposed surface at the top end of the boule.

8. The method of claim 1, wherein the performing comprises processing the boule sequentially through a plurality of workstations to prepare an exposed surface at the top end of the boule then separate respective wafers from the boule while the boule-handling carrier remains attached to the bottom end of the boule.

9. The method of claim 1, wherein the boule-handling carrier comprises an outer perimeter with a shaped edge.

10. The method of claim 9, wherein the shaped edge comprises a fillet, a bevel portion or a chamfer portion.

11. (canceled)

12. The method of claim 5, wherein the angle of inclination is in a range of about 1 degree and about 10 degrees with respect to the first plane.

13. (canceled)

14. The method of claim 1, wherein the boule-handling carrier is ultraviolet light transmissive, and wherein the bonding is performed using an ultraviolet light curable adhesive.

15. The method of claim 1, wherein the boule-handling carrier comprises floated borosilicate glass, and wherein the bonding is performed using a two-part epoxy comprising resin and hardener.

16. The method of claim 4, wherein wafers are separated from the top end of the boule down to a last 300 μm thickness or less of the boule adjacent the bottom end while the boule-holding carrier is bonded to the boule and without the use of manual separation.

17. The method of claim 1, wherein the boule is a silicon carbide boule.

18. The method of claim 2, wherein the grinding is a preparatory grinding to planarize at least a portion of the top end of the boule, wherein the performing further comprises processing the boule sequentially through a plurality of workstations to separate respective wafers from the boule while the boule-handling carrier remains attached to the bottom end of the boule during the processing whereby wafers are separated down to a bottom remnant portion of the boule adjacent the bottom end of the boule.

19. The method of claim 1, wherein the performing comprises sequentially separating a plurality of wafers in response to different wafer separation events, and wherein the boule-handling carrier and the boule remain bonded throughout exposure to ultrasound separation energy applied at a plurality of different times by an ultrasonic separation workstation for at least 10 different wafer separation events to provide the plurality of separated wafers.

20. The method of claim 18, wherein at least one of the plurality of workstations is a grinding workstation which comprises a vacuum chuck that holds the boule-handling carrier bonded to the boule, and wherein the boule-handling carrier and boule remain bonded throughout exposure to load forces applied by the grinding workstation during at least 10 different grinding operations at different times following different separation events to separate respective wafers during the processing.

21. A method of processing crystalline material comprising:
providing a boule of the crystalline material comprising a top end and an opposing bottom end;
bonding a boule-handling carrier to the bottom end of the boule;
separating a wafer from the top end of the boule;
performing at least one of a grinding step and a polishing step after separating the wafer from the boule to grind and/or polish any residual damage on a newly exposed surface at the top end of the boule while the boule-handling carrier remains bonded to the boule; and
maintaining the boule-handling carrier bonded to the bottom end of the boule during subsequent steps of separating whereby wafers are separated down to at least a last 1 mm thickness, optionally down to at least a 300 μm thickness, of the boule adjacent the bottom end.

22.-25. (canceled)

26. A method of processing crystalline material comprising:
providing a boule of the crystalline material comprising a bottom end and an opposing top end;
bonding a boule-handling carrier to the bottom end of the boule;
generating subsurface damage adjacent the top end of the boule;
directing ultrasound energy to the boule to separate a wafer about the subsurface damage from the top end of the boule; then
performing at least one of a grinding and polishing step to a newly exposed substrate surface of the boule after the wafer is separated while the boule-handling carrier remains bonded to the bottom end of the boule; and
repeating the directing and performing steps a plurality of times while the boule-handling carrier remains bonded to the bottom end of the boule.

27.-40. (canceled)
